(19) United States
(12) Patent Application Publication
(10) Pub. No.: US 2023/0309058 A1
(43) Pub. Date: Sep. 28, 2023

(54) ELECTRONIC DEVICE SUPPORTING ULTRA-WIDEBAND COMMUNICATION AND OPERATION METHOD THEREFOR

(71) Applicant: Samsung Electronics Co., Ltd., Suwon-si (KR)

(72) Inventors: Kibong LEE, Suwon-si (KR); Nahyang KIM, Suwon-si (KR); Min SAKONG, Suwon-si (KR); Gaeun LEE, Suwon-si (KR); Jungmin CHO, Suwon-si (KR); Injin HWANG, Suwon-si (KR)

(21) Appl. No.: 18/327,441

(22) Filed: Jun. 1, 2023

Related U.S. Application Data
(63) Continuation of application No. PCT/KR2021/018629, filed on Dec. 9, 2021.

(30) Foreign Application Priority Data
Dec. 17, 2020 (KR) 10-2020-0177789

(51) Int. Cl. H04W 64/00; H04W 8/00

(52) U.S. Cl. CPC H04W 64/006; H04W 8/005

(57) ABSTRACT

An electronic device includes at least one sensor, a first communication module supporting a first communication scheme and configured to transmit a signal for discovery of an external electronic device configured to support a second communication scheme, and receive a first response signal from the external electronic device, and a second communication module supporting the second communication scheme and configured to perform at least one first operation for identifying the location of the external electronic device based on identification that the external electronic device supports the second communication scheme on the basis of the first response signal, and perform at least one second operation for adjusting the location of the external electronic device, based on a first orientation of the electronic device identified based on the at least one sensor, and based on a second orientation of the external electronic device obtained through the first communication module.

### CROSS-REFERENCE TO RELATED APPLICATION(S)

This application is a continuation application, claiming priority under § 365(c), of an International application No. PCT/KR2021/018629, filed on Dec. 9, 2021, which is based on and claims the benefit of a Korean patent application number 10-2020-0177789, filed on Dec. 17, 2020, in the Korean Intellectual Property Office, the disclosure of which is incorporated by reference herein in its entirety.

### BACKGROUND

### 1. Field

The disclosure relates to an electronic device supporting ultra-wideband (UWB) communication and a method of operating the same.

### 2. Description of Related Art

Various network standard technologies have recently been introduced to various electronic devices including portable terminals. wireless-fidelity (Wi-Fi) is newly extending its service frequency to the 6 gigahertz (GHz) band, and new relevant standards such as Wi-Fi Aware, 802.11ay, and 802.11ax are continuously being applied to portable terminals. In addition, the UWB standard that enables short-range communication and precise distance measurement is also being applied to terminals in order to provide car keys and short-range services.

UWB is a wireless communication technology for transmitting a large amount of information with low power over a wide band relative to a spectrum. UWB uses a bandwidth of 500 megahertz (MHz) in a frequency band of 6.25 to 8.25 GHz and a signal with a very short pulse width in units of several ns. Accordingly, UWB is robust against noise. Further, as UWB adopts double-sided two-way ranging (DS-TWR), it may be used for ranging with high accuracy in units of cm.

The above information is presented as background information only to assist with an understanding of the disclosure. No determination has been made, and no assertion is made, as to whether any of the above might be applicable as prior art with regard to the disclosure.

### SUMMARY

The orientation of an electronic device supporting ultra-wideband (UWB) communication and the orientation of an external electronic device may affect determination of the accuracy of information identified based on UWB communication, for example, the distance to the external electronic device and/or a direction in which the external electronic device is located. For example, the information identified based on UWB communication may be accurate or less accurate according to a relative difference between the orientations of the electronic device and the external electronic device. Accordingly, there is a need to develop a method of positioning an external electronic device with high accuracy based on the difference between the orientation of an electronic device and the orientation of the external electronic device.

An electronic device and a method of operating the same according to various embodiments may obtain information about the orientation of an external electronic device based on a first communication scheme, and adjust information identified based on a second communication scheme (e.g., a UWB communication scheme) based on the orientation of the electronic device and the obtained orientation of the external electronic device.

Aspects of the disclosure are to address at least the above-mentioned problems and/or disadvantages and to provide at least the advantages described below. Accordingly, an aspect of the disclosure is to provide an electronic device supporting ultra-wideband (UWB) communication and a method of operating the same.

Additional aspects will be set forth in part in the description which follows and, in part, will be apparent from the description, or may be learned by practice of the presented embodiments.

In accordance with an aspect of the disclosure, an electronic device is provided. The electronic device includes at least one sensor, a first communication module configured to support a first communication scheme, and a second communication module configured to support a second communication scheme. The first communication module may be further configured to transmit a signal for discovery of an external electronic device configured to support the second communication scheme, and receive a first response signal to the signal for discovery from external electronic device, and the second communication module may be further configured to perform at least one first operation for identifying a position of the external electronic device, based on identification that the external electronic device supports the second communication scheme based on the first response signal, and perform at least one second operation for adjusting the position of the external electronic device, based on a first orientation of the electronic device identified based on the at least one sensor, and based on a second orientation of the external electronic device obtained through the first communication module.

In accordance with another aspect of the disclosure, a method performed by an electronic device including at least one sensor, a first communication module configured to support a first communication scheme, and a second communication module configured to support a second communication scheme is provided. The method includes transmitting, by the first communication module, a signal for discovery of an external electronic device configured to support the second communication scheme, receiving, by the first communication module, a first response signal to the signal for discovery from the external electronic device, performing, by the second communication module, at least one first operation for identifying a position of the external electronic device based on identification that the external electronic device supports the second communication scheme based on the first response signal, and performing, by the second communication module, at least one second operation for adjusting the position of the external electronic device, based on a first orientation of the electronic device identified based on the at least one sensor, and based on a second orientation of the external electronic device obtained through the first communication module.

According to various embodiments, an electronic device and a method of operating the same may be provided, which obtains information about the orientation of an external electronic device based on a first communication scheme, and adjusts information identified based on a second communication scheme (e.g., a UWB communication scheme) based on the orientation of the electronic device and the obtained orientation of the external electronic device. Accordingly, the accuracy of the information identified based on the second communication scheme according to the difference in orientation between the two devices may be increased.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIGS. 2A and 2B are flowcharts illustrating a process of measuring a distance based on ultra-wideband (UWB) communication according to various embodiments of the disclosure;

FIG. 2C is a diagram illustrating a direction measurement process based on reception of a UWB signal according to an embodiment of the disclosure;

FIGS. 3A and 3B are diagrams illustrating the difference in orientation between an electronic device and an external electronic device according to various embodiments of the disclosure;

FIG. 4A is a block diagram illustrating an electronic device and an external electronic device according to an embodiment of the disclosure;

FIG. 4B is a diagram illustrating transmission/reception of a communication signal at each antenna of a second communication module according to an embodiment of the disclosure;

FIGS. 5A and 5B are flowcharts illustrating operations of communication modules of an electronic device and communication modules of an external electronic device according to various embodiments of the disclosure;

FIGS. 6A and 6B are flowcharts illustrating a method of operating an electronic device according to various embodiments of the disclosure;

FIGS. 7A and 7B are diagrams illustrating adjustment of an antenna characteristic of a dedicated distance measurement antenna according to various embodiments of the disclosure;

FIG. 8 is a flowchart illustrating a method of operating an electronic device according to an embodiment of the disclosure;

FIG. 9 is a diagram illustrating an antenna switching state based on the difference in orientation between an electronic device and an external electronic device according to an embodiment of the disclosure;

FIG. 10 is a flowchart illustrating a method of operating an electronic device according to an embodiment of the disclosure;

FIG. 11 is a diagram illustrating parameter application according to the difference in orientation between an electronic device and an external electronic device according to an embodiment of the disclosure;

FIG. 12 is a flowchart illustrating a method of operating an electronic device according to an embodiment of the disclosure;

FIG. 13 is a diagram illustrating parameter application based on the difference in orientation between an electronic device and an external electronic device according to an embodiment of the disclosure;

FIG. 14 is a flowchart illustrating a method of operating an electronic device according to an embodiment of the disclosure;

FIG. 15 is a flowchart illustrating a method of operating an electronic device according to an embodiment of the disclosure; and

FIG. 16 is a diagram illustrating an electronic device that communicates with a plurality of external electronic devices according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalent.

It is to be understood that the singular forms “a,” “an,” and “the” include plural referents unless the context clearly dictates otherwise. Thus, for example, reference to “a component surface” includes reference to one or more of such surfaces.

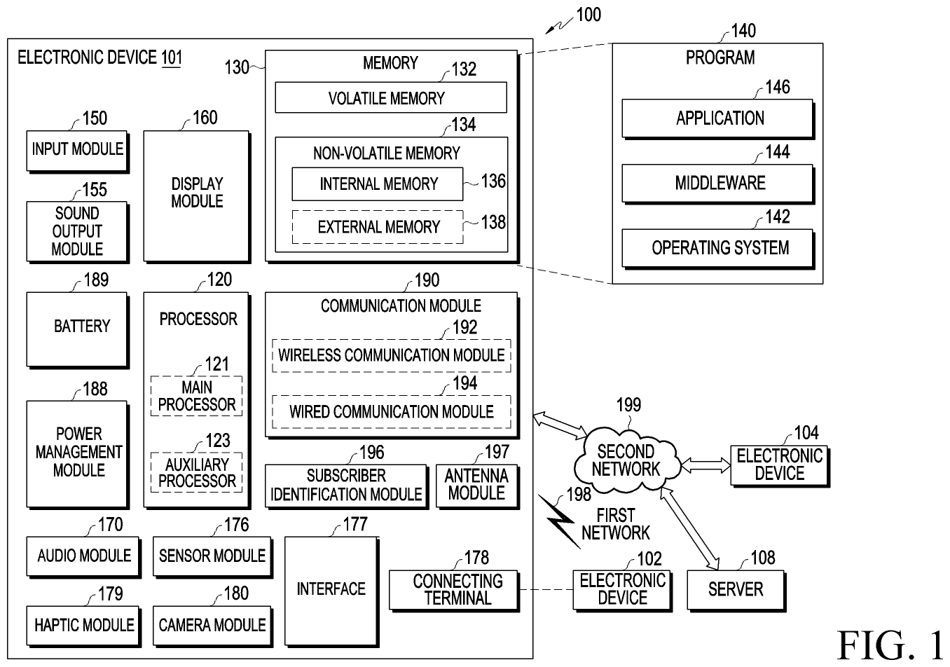

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing units (CPU) or an application processor (AP)), or an auxiliary processor 123 (e.g., a graphics processing units (GPU), a neural processing units (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a board (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency (RF) integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

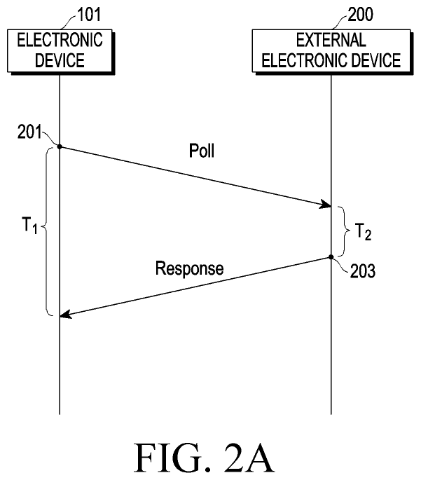

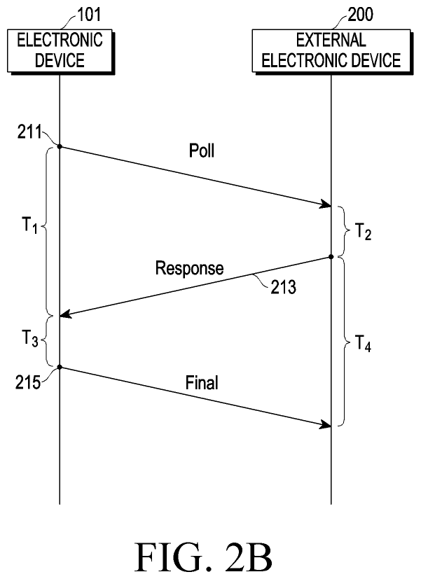

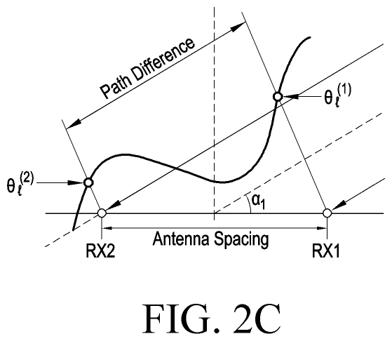

FIGS. 2A and 2B are flowcharts illustrating a process of measuring a distance based on UWB communication according to various embodiments of the disclosure.

Referring to FIG. 2A, the electronic device 101 (e.g., the processor 120 and/or the communication module 190) according to various embodiments may identify a distance to the external electronic device 200 based on a single-side two way ranging method (SS-TWR) scheme. In operation 201, the electronic device 101 may transmit a poll message (e.g., ranging poll). For example, the communication module 190 may include a UWB communication module, and the UWB communication module may transmit the poll message. The external electronic device 200 may receive the poll message and transmit a response message (e.g., ranging response) in response to the poll message in operation 203. To receive the poll message and transmit the response message corresponding to the poll message, the external electronic device 200 may consume a second time T2, and the second time may be referred to as, for example, a process time. The external electronic device 200 may include information about the process time, for example, the second time T2 in the response message and transmit the response message to the electronic device 101.

The electronic device 101 according to various embodiments may identify the distance between the electronic device 101 and the external electronic device 200 based on a transmission time of the poll message, a reception time of the response message, and the process time (e.g., the second time T2) included in the response message. For example, when the difference between the transmission time of the poll message and the reception time of the response message is a first time T1, the electronic device 101 may identify (T1−T2)/(2c) (where c is the speed of light) as the distance between the electronic device 101 and the external electronic device 200.

Referring to FIG. 2B, the electronic device 101 (e.g., the processor 120 and/or the communication module 190) according to various embodiments may identify a distance to the external electronic device 200 based on a double-sided two-way ranging (DS-TWR) scheme. In operation 211, the electronic device 101 may transmit a poll message. For example, the communication module 190 may include a UWB communication module, and the UWB communication module may transmit the poll message. The external electronic device 200 may receive the poll message and transmit a response message in response to the poll message in operation 213. To receive the poll message and transmit the response message corresponding to the poll message, the external electronic device 200 may consume a process time of a second time T2. The external electronic device 200 may include information about the process time, for example, the second time T2 in the response message and transmit the response message to the electronic device 101.

According to various embodiments, in operation 215, the electronic device 101 may transmit a final message (e.g., ranging final) based on reception of the response message. For example, to receive the response message and transmit the final message corresponding to the response message, the external electronic device 200 may consume a process time of a third time T3. The electronic device 101 may include information about the processing time, for example, the third time T3 in the final message and transmit the final message to the external electronic device 200.

The electronic device 101 according to various embodiments may identify the distance between the electronic device 101 and the external electronic device 200 based on a transmission time of the poll message, a reception time of the response message, and the process time included in the response message (e.g., the second time T2). The external electronic device 200 according to various embodiments identify the distance between the electronic device 101 and the external electronic device 200 based on a transmission time of the response message, a reception time of the final message, and the process time (e.g., the third time T) included in the final message. For example, when the difference between the transmission time of the response message and the reception time of the final message is a fourth time T4, the electronic device 101 may identify (T4-T3)/(2c) (where c is the speed of light) as the distance between the electronic device 101 and the external electronic device 200.

FIG. 2C is a diagram illustrating a direction measurement process based on reception of a UWB signal according to an embodiment of the disclosure.

Referring to FIG. 2C, the electronic device 101 (e.g., the processor 120 and/or the communication module 190) according to various embodiments may identify a direction of the external electronic device 200 with respect to the electronic device 101 based on an angle of arrival (AOA) scheme. For example, the communication module 190 (e.g., the UWB communication module) of the electronic device 101 may support two reception antennas RX1 and RX2. The two reception antennas RX1 and RX2 may be disposed with an antenna spacing. It is assumed that the external electronic device 200 is located in a direction of an angle cd with respect to the electronic device 101. The reception times and phases of a signal at the two reception antennas RX1 and RX2 are different due to the antenna spacing. For example, the phase of the signal received at the first antenna RX1 may be θ1(1), and the phase of the signal received at the second antenna RX2 may be θ1(2). The electronic device 101 may identify the angle cd at which the external electronic device 200 is located, based on the difference between the phases measured at the reception antennas RX1 and RX2 (or the difference between the reception times measured at the reception antennas) and the antenna spacing.

According to various embodiments, the electronic device 101 may identify a first angle as the direction in which the external electronic device 200 is located with respect to the electronic device 101, based on the measurement results of the two reception antennas RX1 and RX2. According to various embodiments, the electronic device 101 may include three or more reception antennas. The electronic device 101 may identify a first angle, which is the direction in which the external electronic device 200 is located with respect to the electronic device 101 based on measurement results of two reception antennas of a first combination, and identify a second angle, which is the direction in which the external electronic device 200 is located with respect to the electronic device 101 based on measurement results of two reception antennas of a second combination.

As described above, the electronic device 101 may identify the distance to the external electronic device 200 and/or the direction of the external electronic device 200.

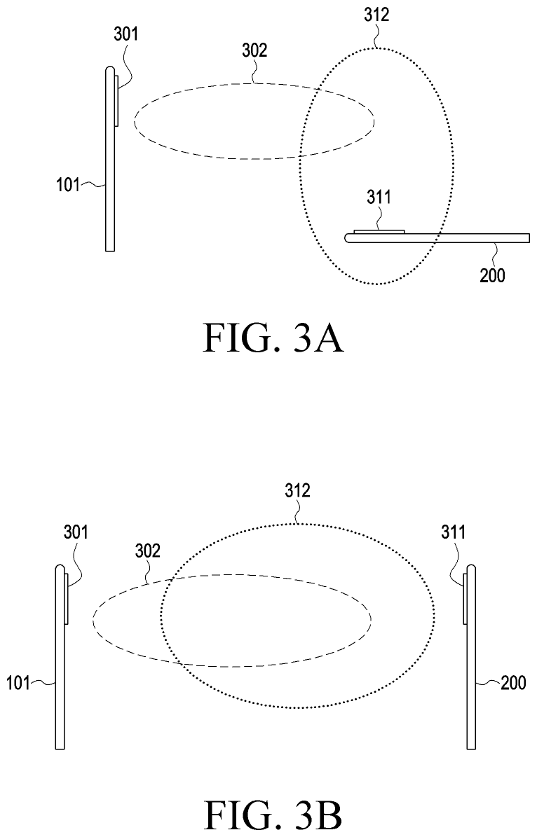

FIGS. 3A and 3B are diagrams illustrating the difference in orientation between an electronic device and an external electronic device according to various embodiments of the disclosure.

Referring to FIG. 3A, the electronic device 101 according to various embodiments may include at least one antenna 301, and the external electronic device 200 may include at least one antenna 311. The at least one antenna 301 may form a first radiation pattern 302, and the at least one antenna 311 may form a second radiation pattern 312. For example, as illustrated in FIG. 3A, the orientation of the electronic device 101 may be a first orientation, the orientation of the external electronic device 200 may be a second orientation, and the first orientation and the second orientation may be substantially orthogonal to each other. Since the electronic device 101 and/or the external electronic device 200 may be implemented as a portable device, the orientation is freely changed. Accordingly, a relative difference between the orientation of the electronic device 101 and the orientation of the external electronic device 200 may be changed. For example, referring to FIG. 3B, the orientation of the electronic device 101 may be the first orientation, the orientation of the external electronic device 200 may be a third orientation, and the first orientation and the third orientation may be substantially identical (or parallel).

For example, the orthogonality of orientations as in illustrated FIG. 3A may cause orthogonality of radiation patterns and/or polarization mismatch between the electronic devices 101 and 200. When the orientations are different as in FIG. 3A, an error in the direction (e.g., the angle α1 of FIG. 2C) of the external electronic device 200 identified by the electronic device 101 may be greater than an error in the direction identified when the orientations are identical (or parallel) as in FIG. 3B. In addition, a measurable distance to the external electronic device 200 identified by the electronic device 101 in the case of different orientations as in FIG. 3A may be less than in the case of identical (or parallel) orientations as in FIG. 3B. Accordingly, there may be a need for identifying (or adjusting) the position of the external electronic device 200 (e.g., the distance to the external electronic device 200 and/or the direction of the external electronic device 200) in consideration of the orientation of the electronic device 101 and the orientation of the external electronic device 200.

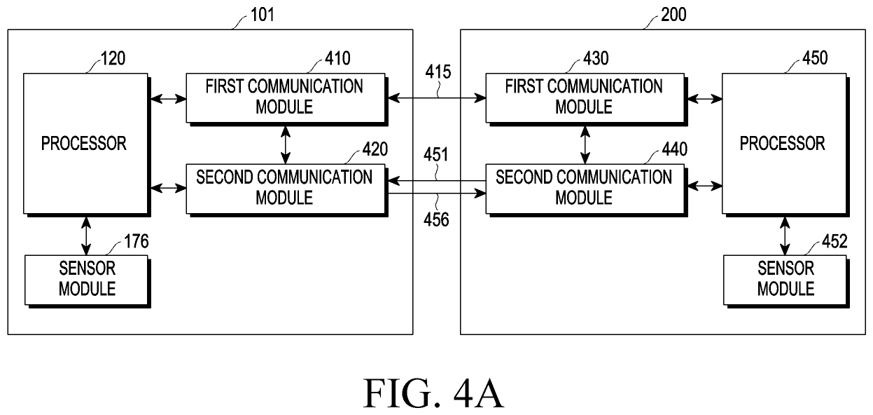

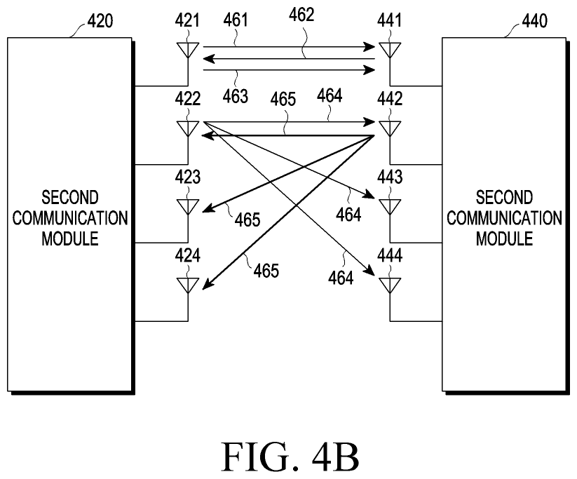

FIG. 4A is a block diagram illustrating an electronic device and an external electronic device according to an embodiment of the disclosure. The embodiment of FIG. 4A will be described with reference to FIG. 4B. FIG. 4B is a diagram illustrating transmission/reception of a communication signal at each antenna of a second communication module according to an embodiment of the disclosure.

The electronic device 101 according to various embodiments may include at least one of the processor 120, the sensor module 176, a first communication module 410, or a second communication module 420. The external electronic device 200 may include at least one of a first communication module 430, a second communication module 440, a processor 450, or a sensor module 452. The first communication module 410 of the electronic device 101 and the first communication module 430 of the external electronic device 200 may support a first communication scheme. The second communication module 420 of the electronic device 101 and the second communication module 440 of the external electronic device 200 may support a second communication scheme. The second communication scheme is a communication scheme for identifying, for example, the position of the external electronic device 200 (e.g., the distance to the external electronic device 200 and/or the direction of the external electronic device 200), and may be UWB communication. However, the communication scheme is not limited. The first communication scheme may be, for example, a Bluetooth (or Bluetooth low energy (BLE)) communication scheme. However, as far as it is different from the second communication scheme, the first communication scheme is not limited. Those skilled in the art will understand that depending on implementation, the external electronic device 200 may be implemented as a tag device that simply transmits a UWB communication signal. For example, the first communication scheme may be a Zigbee, Wi-Fi, and/or near field communication (NFC) communication scheme, and its type is not limited.

According to various embodiments, the first communication module 410 may establish a communication connection 415 with the first communication module 430 based on the first communication scheme. For example, when the first communication scheme is BLE communication, the first communication module 410 and the first communication module 430 may establish a BLE connection. The BLE connection may be established, for example, based on signal transmission/reception between the first communication module 410 and the first communication module 430, which should not be construed as limiting.

According to various embodiments, the sensor module 176 may sense at least one data for identifying the orientation of the electronic device 101. The processor 120 may identify the orientation of the electronic device 101 based on the at least one data from the sensor module 176. The sensor module 452 may sense at least one data for identifying the orientation of the external electronic device 200. The processor 450 may identify the orientation of the external electronic device 200 based on the at least one data from the sensor module 452. The sensor module 176 and/or the sensor module 452 may include, for example, an acceleration sensor, a gyro sensor, and/or a geomagnetic sensor. However, the type of a sensor is not limited. Although the orientation of the electronic device 101 and/or the orientation of the external electronic device 200 may be expressed as, for example, at least one angle, the expression form is not limited.

According to various embodiments, the electronic device 101 may receive a communication signal including information about the orientation of the external electronic device 200 through the first communication module 410. The processor 450 may identify the orientation of the external electronic device 200 and transmit the communication signal including information about the orientation through the first communication module 430.

According to various embodiments, the second communication module 420 may transmit and receive communication signals 451 and 456 (e.g., UWB signals) based on the second communication scheme. The processor 120 and/or the second communication module 420 may identify the position of the external electronic device 200 (e.g., the distance to the external electronic device 200 and/or the direction of the external electronic device 200) based on a measurement result of the communication signal 456. The processor 450 and/or the second communication module 440 may identify the position of the electronic device 101 (e.g., the distance to the electronic device 101 and/or the direction of the electronic device 101) based on a measurement result of the communication signal 451.

According to various embodiments, as illustrated in FIG. 4B, the second communication module 420 may include a dedicated distance measurement antenna 421 and patch antennas 422, 423, and 424. The second communication module 440 may include a dedicated distance measurement antenna 441 and patch antennas 442, 443, and 444. The dedicated distance measurement antennas 421 and 441 may be implemented as, for example, metal antennas or laser direct structuring (LDS) antennas. However, their implementation forms are not limited. In addition to the second communication scheme (e.g., UWB communication), the dedicated distance measurement antennas 421 and 441 may be implemented for use in a 3rd generation partnership project (3GPP)-based radio access technology (RAT) (e.g., evolved-universal terrestrial radio access (E-UTRA) or NR). In this case, the dedicated distance measurement antennas 421 and 441 may be used as shared antennas for 3GPP-based RAT and UWB communication. Although the patch antennas 422, 423, 424, 442, 443, and 444 may be implemented as, for example, patch antennas, the implementation form is not limited. For example, the patch antennas 422, 423, 424, 442, 443, and 444 may be implemented as dipole antennas, slot antennas, and/or slit antennas, and their types are not limited. The second communication module 420 may include an RF path for transmitting an RF signal to the dedicated distance measurement antenna 421 and an RF path for receiving an RF signal from the dedicated distance measurement antenna 421, and thus the dedicated distance measurement antenna 421 may be used for both transmission and reception of communication signals. The second communication module 420 may include an RF path for transmitting an RF signal to the patch antenna 422 and an RF path for receiving an RF signal from the patch antenna 422. Accordingly, the patch antenna 422 may be used for both transmission and reception of communication signals. The second communication module 420 may include RF paths for receiving an RF signal from the patch antennas 423 and 424, and accordingly, the patch antennas 423 and 424 may be used for receiving a communication signal. The second communication module 440 may include an RF path for transmitting an RF signal to the dedicated distance measurement antenna 441 and an RF path for receiving an RF signal from the dedicated distance measurement antenna 441. Accordingly, the dedicated distance measurement antenna 441 may be used for both transmission and reception of communication signals. The second communication module 440 may include an RF path for transmitting an RF signal to the patch antenna 442 and an RF path for receiving an RF signal from the patch antenna 442. Accordingly, the patch antenna 442 may be used for both transmission and reception of communication signals. The second communication module 440 may include RF paths for receiving an RF signal from the patch antennas 443 and 444, and accordingly, the patch antennas 443 and 444 may be used for receiving a communication signal.

According to various embodiments, the second communication module 420 may transmit a communication signal 461 (e.g., the poll message of FIG. 2A or 2B) using the dedicated distance measurement antenna 421. The second communication module 440 may receive the communication signal 461 using the dedicated distance measurement antenna 441. The second communication module 440 may transmit a communication signal 462 (e.g., the response message of FIG. 2A or 2B) using the dedicated distance measurement antenna 441. The second communication module 420 may receive the communication signal 462 using the dedicated distance measurement antenna 421. The second communication module 420 may transmit a communication signal 463 (e.g., the final message of FIG. 2B) using the dedicated distance measurement antenna 421. The second communication module 440 may receive the communication signal 463 using the dedicated distance measurement antenna 441. The second communication module 420 may identify the distance between the electronic device 101 and the external electronic device 200 based on a transmission time of the communication signal 461, a reception time of the communication signal 462, and a process time of the external electronic device 200 obtained from the communication signal 462. The second communication module 440 may identify the distance between the electronic device 101 and the external electronic device 200 based on a transmission time of the communication signal 462, a reception time of the communication signal 463, and a process time of the external electronic device 200 obtained from the communication signal 463. The second communication module 420 may identify the distance between the electronic device 101 and the external electronic device 200 using the dedicated distance measurement antenna 421.

According to various embodiments, the second communication module 420 may transmit a communication signal 464 using the patch antenna 422. The communication signal 464 may be measured at the patch antennas 442, 443, and 444 of the second communication module 440. Measurement times and/or measured phases of the communication signal 464 may be different based on antenna spacings among the patch antennas 442, 443, and 444. The second communication module 440 may identify the direction of the electronic device 101 with respect to the external electronic device 200 based on the differences among measurement times and/or measured phases corresponding to the patch antennas 442, 443, and 444. The second communication module 440 may transmit a communication signal 465 using the patch antenna 442, and measurement times and/or measured phases of the communication signal 465 may be different based on antenna spacings among the patch antennas 422, 423, and 424. The second communication module 420 may identify the direction of the external electronic device 200 with respect to the electronic device 101 based on the differences among the measurement times and/or the measured phases corresponding to the patch antennas 422, 423, and 424. The second communication module 420 may identify the distance between the electronic device 101 and the external electronic device 200 based on a transmission time of the communication signal 464, a reception time of the communication signal 465, and a process time of the external electronic device 200 obtained from the communication signal 465. The second communication module 420 may identify the distance between the electronic device 101 and the external electronic device 200 and the direction of the external electronic device 200 at least simultaneously using the patch antennas 422, 423, and 424.

In various embodiments of the disclosure, measuring the position of the external electronic device 200 by the electronic device 101 may mean any one of, for example, measuring both the distance and direction of the external electronic device 200 using a plurality of antennas (e.g., the patch antennas 422, 423, and 424) and measuring the distance to the external electronic device 200 using a single antenna (e.g., the dedicated distance measurement antenna 421).

As described above, the position of the external electronic device 200 (e.g., the distance to the external electronic device 200 and/or the direction of the external electronic device 200) may have a relatively large error according to the orientation of the electronic device 101 and the orientation of the external electronic device 200. The electronic device 101 may perform at least one operation for adjusting the position of the external electronic device 200 based on the orientation of the electronic device 101 and the orientation of the external electronic device 200. For example, the electronic device 101 may perform an operation for adjusting the position of the electronic device 101 and/or the external electronic device 200 (e.g., adjusting an antenna setting and/or a measured direction) based on the orientation of the electronic device 101 and the orientation of the external electronic device 200.

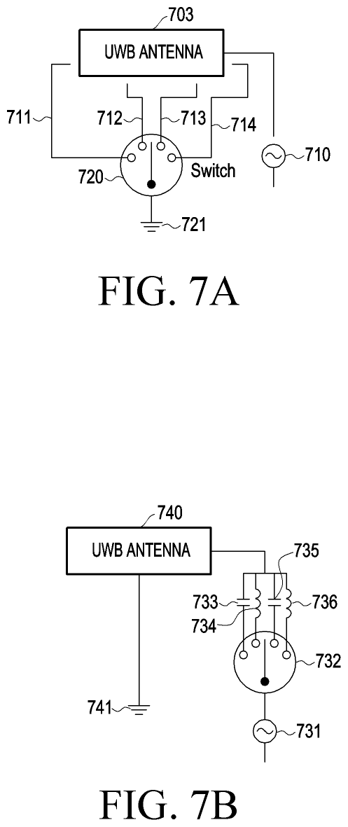

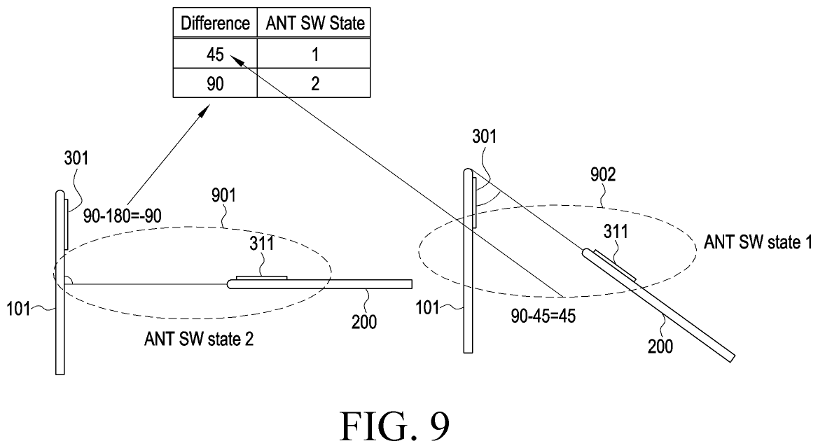

According to various embodiments, the processor 120 may perform at least one operation for adjusting the position of the external electronic device 200 based on an orientation of the electronic device 101 identified based on data from the sensor module 176 and an orientation of the external electronic device 200 identified based on a communication signal received through the first communication module 410. For example, the electronic device 101 may perform at least one operation for adjusting an antenna characteristic of the dedicated distance measurement antenna 421 and/or the patch antennas 422, 423, and 424 (e.g., adjusting the length of a wire associated with the dedicated distance measurement antenna 421). A maximum measurement distance may increase based on the operation associated with the dedicated distance measurement antenna 421, compared to before the operation. The operation for adjusting an antenna characteristic of the dedicated distance measurement antenna 421 will be described with reference to FIGS. 7A and 7B. For example, the second communication module 420 may perform at least one operation for adjusting the phases of a signal input to the patch antennas 422, 423, and 424. For example, the electronic device 101 may identify a corrected direction by correcting the direction (e.g., angle) of the external electronic device 200 (e.g., by applying an offset). Correction of the direction of the external electronic device 200 will be described with reference to FIG. 9.

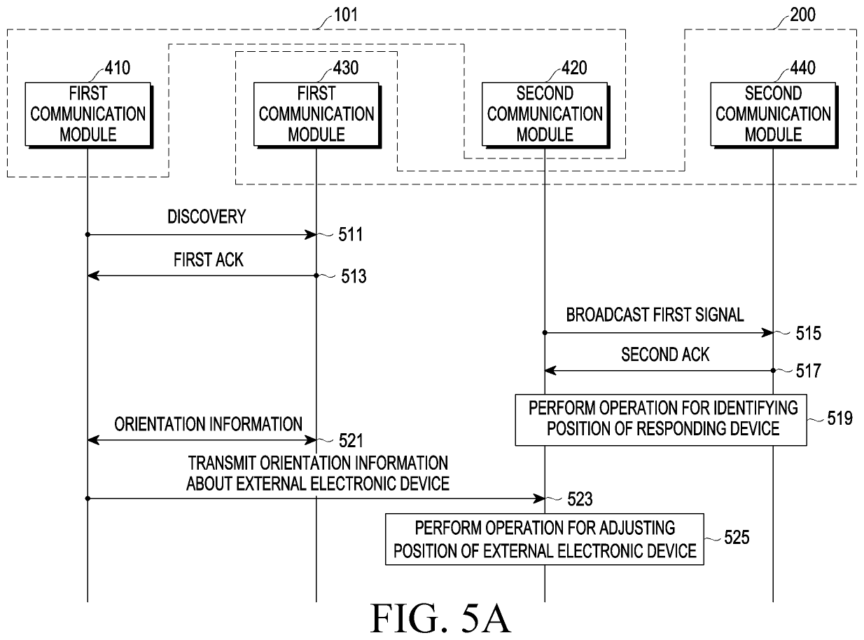

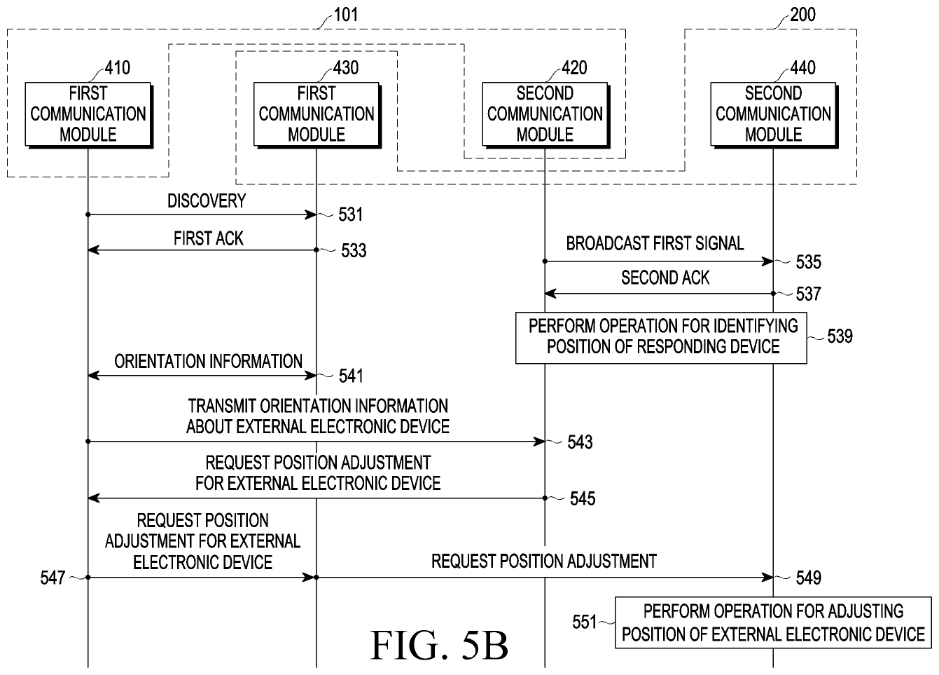

FIG. 5A is a flowchart illustrating operations of communication modules of an electronic device and communication modules of an external electronic device according to an embodiment of the disclosure.

According to various embodiments, the first communication module 410 of the electronic device 101 and the first communication module 430 of the external electronic device 200 may transmit and receive signals to and from each other according to the first communication scheme (e.g., BLE communication). The second communication module 420 of the electronic device 101 and the second communication module 440 of the external electronic device 200 may transmit and receive signals to and from each other according to the second communication scheme. The first communication module 410 may transmit a discovery signal in operation 511. The discovery signal may be, for example, a signal for discovering a device supporting the second communication scheme (e.g., UWB communication). The discovery signal may include, for example, at least one piece of identification information about the electronic device 101. The discovery signal may include, for example, information indicating whether the electronic device 101 supports the second communication scheme (e.g., UWB communication).

According to various embodiments, in operation 513, the first communication module 430 may transmit a first acknowledgment (ACK) signal in response to the discovery signal. For example, when the external electronic device 200 supports the second communication scheme (e.g., UWB communication), the external electronic device 200 may transmit the first ACK signal through the first communication module 430 in response to the discovery signal. For example, at least one piece of identification information about the external electronic device 200 may be included in the first ACK signal. For example, the first ACK signal may include information indicating whether the second communication scheme (e.g., UWB communication) is supported. For example, the first ACK signal may include information indicating whether the second communication scheme (e.g., UWB communication) is available. The electronic device 101 may store the identification information (e.g., identification information based on the first communication scheme) about the external electronic device 200 and the information about the second communication scheme (e.g., support or non-support and/or availability or unavailability of the second communication scheme (e.g., UWB communication) in association with each other. When the identification information about the external electronic device 200 based on the first communication scheme is “aa:aa:aa:aa:aa:aa”, and it is identified based on the first ACK signal that the second communication scheme (e.g., UWB communication) is supported by and available to the external electronic device 200, the electronic device 101 may store the identification information, “aa:aa:aa:aa:aa:aa”, support or non-support of the second communication scheme, “UwBsupport=true”, and availability or unavailability of the second communication scheme, “UwBavailable=true” in association with each other. The stored information may also be referred to by the first communication module 410 and/or the second communication module 420.

According to various embodiments, in operation 515, the second communication module 420 may transmit (e.g., broadcast) a first signal (e.g., a UWB signal) based on the second communication scheme (e.g., UWB communication). In operation 517, the second communication module 440 may transmit a second ACK signal based on the second communication scheme (e.g., UWB communication) in response to the first signal. Broadcasting of the first signal and reception of the second ACK signal may be omitted depending on implementation. In operation 519, the second communication module 420 and the second communication module 440 may perform an operation for locating their responding devices. For example, the second communication module 420 of the electronic device 101 may perform an operation for locating the external electronic device 200 based on the second ACK signal. In an example, the electronic device 101 may identify the distance to the external electronic device 200 and the direction of the external electronic device 200 at least simultaneously using a plurality of antennas (e.g., the patch antennas). In this case, the electronic device 101 may transmit a UWB signal, and the external electronic device 200 may respond with a UWB signal. The second communication module 420 may identify the distance to the external electronic device 200 based on a transmission time of the UWB signal, a reception time of the UWB signal from the external electronic device 200, and a process time of the external electronic device 200. The second communication module 420 may identify the direction of the external electronic device 200 based on a difference in reception characteristics (e.g., a difference in reception time and/or a difference in reception phase) of the UWB signal between the plurality of antennas. In another example, the electronic device 101 may identify the distance to the external electronic device 200 using a single antenna (e.g., a metal antenna or a laser scanning display (LSD) antenna). In various examples, the electronic device 101 and the external electronic device 200 may exchange settings for positioning based on the first communication scheme and/or the second communication scheme. A positioning operation may be performed based on the exchanged settings for positioning.

According to various embodiments, in operation 521, the first communication module 410 of the electronic device 101 and the first communication module 430 of the external electronic device 200 may transmit and receive orientation information. The electronic device 101 may transmit information about the orientation of the electronic device 101 to the external electronic device 200 based on the first communication scheme. The electronic device 101 may receive information about the orientation of the external electronic device 200 from the external electronic device 200 based on the first communication scheme. A communication signal based on the first communication scheme may include at least one piece of identification information and the information about the orientation, and may additionally include information about the position of the other device identified based on the second communication scheme. Those skilled in the art will understand that transmission (or reception) of any one of the information about both orientations may be omitted. In operation 523, the first communication module 410 may transmit the received information about the orientation of the external electronic device 200 to the second communication module 420. In an example, the first communication module 410 may transmit the information about the orientation of the external electronic device 200 to the second communication module 420 through the processor 120, whereas in another example, the first communication module 410 may transmit the information about the orientation of the external electronic device 200 directly to the second communication module 420.

According to various embodiments, in operation 525, the second communication module 420 may perform an operation for adjusting the position of the external electronic device 200. For example, the second communication module 420 may perform the operation for adjusting the position of the external electronic device 200 based on the received information about the orientation of the external electronic device 200 and the received orientation of the electronic device 101. For example, the second communication module 420 may determine a parameter (e.g., any one parameter in a lookup table) for correcting the direction of the external electronic device 200 based on the two orientations, and apply the parameter. For example, the second communication module 420 may adjust an antenna characteristic for distance measurement based on the two orientations. Although not shown, after performing the operation for adjusting the position of the external electronic device 200 in operation 525, the second communication module 420 and the second communication module 440 may additionally perform an operation for locating their responding devices as in operation 519. Performing the position adjustment operation by receiving both of the orientation of the electronic device 101 and the orientation of the external electronic device 200 by the second communication module 420 is merely an example. The second communication module 420 may receive the difference between the orientation of the electronic device 101 and the orientation of the external electronic device 200, and perform the position adjustment operation using the received difference. Alternatively, the processor 120 may identify setting information for position adjustment based on the orientation of the electronic device 101 and the orientation of the external electronic device 200, and provide the setting information to the second communication module 420. In this case, the second communication module 420 may perform the position adjustment operation based on the setting information received from the processor 120.

As described above, the information about the orientations of both the electronic devices 101 and 200 is exchanged based on the first communication scheme (e.g., BLE communication), and the position adjustment operation (e.g., antenna setting adjustment and/or measured direction adjustment) is performed based on the orientations of both the electronic devices 101 and 200. Therefore, the possibility of a positioning accuracy decrease or a maximum measurable distance decrease due to orientation mismatch between the two electronic devices 101 and 200 may be reduced.

FIG. 5B is a flowchart illustrating operations of communication modules of an electronic device and communication modules of an external electronic device according to an embodiment of the disclosure. Operations 531, 533, 535, 537, 539, 541, and 543 in FIG. 5B may be substantially identical or similar to operations 511, 513, 515, 517, 519, 521, and 523 in FIG. 5A, and a detailed description thereof will be omitted herein.

According to various embodiments, the second communication module 420 of the electronic device 101 may request position adjustment for the external electronic device 200 in operation 545. For example, when the second communication module 420 is unable to perform the position adjustment operation, the second communication module 420 may be implemented to request to make the external electronic device 200 to perform position adjustment. The first communication module 410 may request position adjustment from the external electronic device 200 based on the request from the second communication module 420 in operation 547. In operation 549, the first communication module 430 of the external electronic device 200 may forward the position adjustment request from the electronic device 101 to the second communication module 440. The second communication module 440 of the external electronic device 200 may perform an operation for adjusting the position of the electronic device 101 in operation 551. For example, the second communication module 440 may perform the operation for adjusting the position of the electronic device 101 based on the orientation of the electronic device 101 and the orientation of the external electronic device 200. In various embodiments, the external electronic device 200 may be configured to perform the operation for adjusting the position of the electronic device 101, even without receiving a request from the electronic device 101.

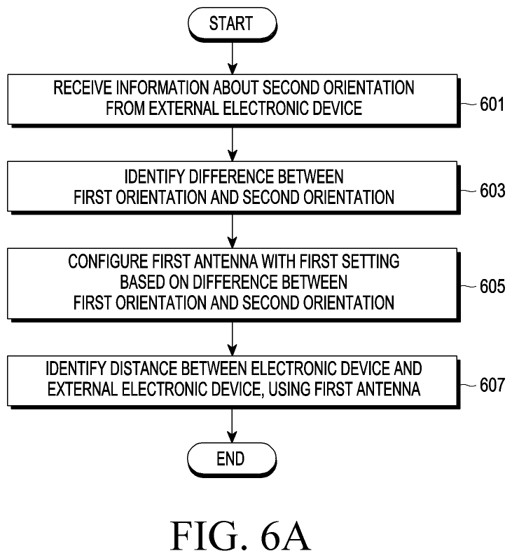

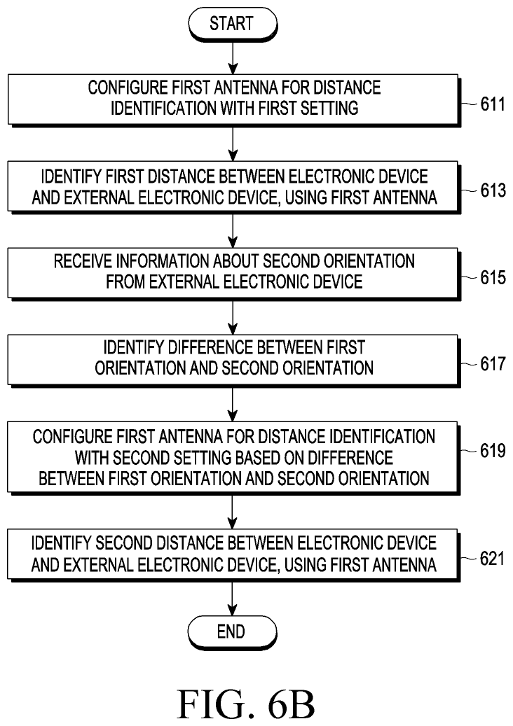

FIGS. 6A and 6B are flowcharts illustrating a method of operating an electronic device according to various embodiments of the disclosure. The embodiment of FIGS. 6A and 6B will be described with reference to FIGS. 7A and 7B.

FIGS. 7A and 7B are diagrams illustrating antenna characteristic adjustment of a dedicated distance measurement antenna according to various embodiments of the disclosure.

Referring to FIG. 6A, according to various embodiments, the electronic device 101 (e.g., the processor 120 and/or the first communication circuit 610) may receive information about a second orientation from the external electronic device 200 in operation 601. As described above, the external electronic device 200 may identify the second orientation of the external electronic device 200 based on data from the sensor module 452. The external electronic device 200 may transmit a communication signal including the information about the second orientation based on the first communication scheme. The electronic device 101 may receive the communication signal including the information about the second orientation based on the first communication scheme and identify the second orientation of the external electronic device 200 from the communication signal.

According to various embodiments, the electronic device 101 (e.g., the processor 120 and/or the second communication module 420) may identify the difference between a first orientation and the second orientation in operation 603. As described above, the electronic device 101 may identify the first orientation of the electronic device 101 based on data from the sensor module 176. In operation 605, the electronic device 101 may configure a first antenna with a first setting based on the difference between the first orientation and the second orientation. For example, the electronic device 101 may pre-store association information between differences between the first orientation and the second orientation and antenna settings. Table 1 is an example of a part of association information between orientation differences and antenna settings.

TABLE 1

| Orientation difference | Antenna setting |
|---|---|
| 0° or above to 45° or below | First antenna setting |
| 45° or above to 90° or below | Second antenna setting |
| 90° or above to 135° or below | Third antenna setting |
| 135° or above to 180° or below | Fourth antenna setting |

For example, Table 1 is an example of a case in which the orientations of the electronic device 101 and the external electronic device 200 are each expressed as a one-dimensional angle, and those skilled in the art will understand that the dimension corresponding to the orientation differences in the association information of Table 1 is not limited, and may depend on the dimension in which the orientations are expressed. Those skilled in the art will also understand that representation of the differences in orientation as ranges in Table 1 is also exemplary, and the ranges may be replaced with specified values. For example, the electronic device 101 may identify that the first orientation of the electronic device 101 is 40°, and the second orientation of the external electronic device 200 is 30°. The electronic device 101 may identify the difference between the first orientation and the second orientation as 40°-30°, that is, 10°. The electronic device 101 may identify a first antenna setting corresponding to the difference based on the association information, for example, as shown in Table 1.

For example, referring to FIG. 7A, a first stub 711, a second stub 712, a third stub 713, and a fourth stub 714 may be connected to a UWB antenna 703 based on the second communication scheme (e.g., UWB communication) of the electronic device 101. The electronic device 101 may include a switch 720 which may selectively connect at least one of the stubs 711, 712, 713, and 714 to a ground 721. Those skilled in the art will understand that at least one element generating and/or transmitting an RF signal applied to the UWB antenna 703 is represented as an RF source 710. An operation for controlling the switch 720 to connect a specified stub by the electronic device 101 may be understood as configuring an antenna setting. For example, when the first antenna setting is selected, the electronic device 101 may control the switch 720 to connect the first stub 711 to the ground 721. The stubs 711, 712, 713, and 714 may have different physical lengths, and thus RF signals input to and/or output from the dedicated distance measurement antenna when the stubs 711, 712, 713, and 714 are connected may have different phases. The electronic device 101 may identify the antenna setting based on the identified orientation difference and control the switch 720 to connect at least one of the at least one stub 711, 712, 713, and 714 based on the antenna setting. When the electronic device 101 identifies the first antenna setting, it may control the switch 720 to connect the first stub 711 to the ground 721. According to various embodiments, the electronic device 101 (e.g., the processor 120 and/or the second communication module 420) may identify the distance between the electronic device 101 and the external electronic device 200, using the first antenna in operation 607. For example, the electronic device 101 may transmit a poll message and receive a response message, using the first antenna, and identify a first distance based on the message transmission and reception. As the optimal antenna setting is configured, the maximum measurement distance of the electronic device 101 may increase.

Referring to FIG. 6B, according to various embodiments, the electronic device 101 (e.g., the processor 120 and/or the second communication module 420) may configure the first antenna (e.g., the dedicated distance measurement antenna 421 of FIG. 4B) with the first setting in operation 611. For example, when the first antenna setting is selected, the electronic device 101 may control the switch 720 to connect the first stub 711 to the ground 721. The stubs 711, 712, 713, and 714 may have different physical lengths, and thus, RF signals input to and/or output from the dedicated distance measurement antenna when the stubs 711, 712, 713, and 714 are connected may have different phases.

According to various embodiments, in operation 613, the electronic device 101 may identify a first distance between the electronic device 101 and the external electronic device 200, using the first antenna configured with the first antenna setting. For example, the electronic device 101 may transmit a poll message and receive a response message using the first antenna, and identify the first distance based on the message transmission and reception.

According to various embodiments, the electronic device 101 (e.g., the processor 120 and/or the first communication circuit 610) may receive information about a second orientation from the external electronic device 200 in operation 615. As described above, the external electronic device 200 may identify the second orientation of the external electronic device 200 based on data from the sensor module 452. The external electronic device 200 may transmit a communication signal including the information about the second orientation based on the first communication scheme. The electronic device 101 may receive the communication signal including the information about the second orientation based on the first communication scheme, and identify the second orientation of the external electronic device 200 from the communication signal.

According to various embodiments, the electronic device 101 (e.g., the processor 120 and/or the second communication module 420) may identify the difference between a first orientation and the second orientation in operation 617. As described above, the electronic device 101 may identify the first orientation of the electronic device 101 based on data from the sensor module 176. In operation 619, the electronic device 101 may configure the first antenna with a second setting based on the difference between the first orientation and the second orientation. For example, the electronic device 101 may configure the first antenna with the second setting based on the association information shown in Table 1. According to various embodiments, the electronic device 101 (e.g., the processor 120 and/or the second communication module 420) may identify a second distance between the electronic device 101 and the external electronic devices 200, using the first antenna in operation 621. In some cases, the second distance may be the same as the first distance within a tolerance range. However, as the optimal antenna setting is configured, the maximum measurement distance of the electronic device 101 may increase.

According to various embodiments, the second communication module 420 of the electronic device 101 may be implemented to have a configuration as shown in FIG. 7B.

For example, referring to FIG. 7B, a plurality of elements (e.g., a first capacitor 733, a first inductor 734, a second capacitor 735, and a second inductor 736) may be connected to a UWB antenna 740 of the electronic device 101 based on the second communication scheme (e.g., UWB communication). The electronic device 101 may include a switch 732 which may selectively connect at least one of the elements 733, 734, 735, and 736 to a ground 741. Those skilled in the art will understand that at least one element generating and/or transmitting an RF signal applied to the UWB antenna 740 is represented as an RF source 731. Those skilled in the art will understand an operation for controlling the switch 732 to a specified element by the electronic device 101 as configuring an antenna setting. For example, when the first antenna setting is selected, the electronic device 101 may control the switch 732 to connect the first capacitor 733 to the ground 741. When the 902, 734, 735, and 736 are connected, RF signals input to and/or output from the dedicated distance measurement antenna may have different phases.

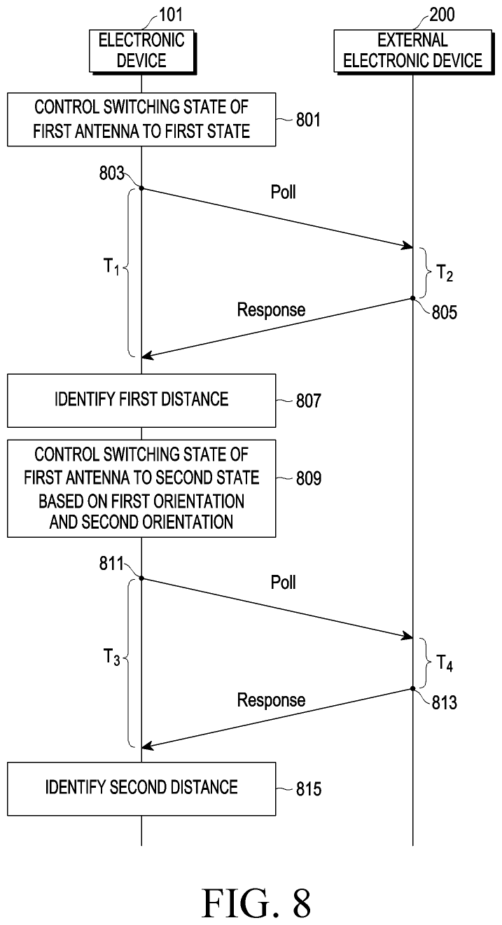

FIG. 8 is a flowchart illustrating a method of operating an electronic device according to an embodiment of the disclosure.

According to various embodiments, the electronic device 101 (e.g., the processor 120 and/or the second communication module 420) may control the switching state of a first antenna for distance measurement to a first state in operation 801. For example, the first state may be a default state or a state set based on a previously measured difference in orientation between the electronic device 101 and the external electronic device 200.

Referring to FIG. 8, in operation 803, the electronic device 101 may transmit a poll message using the first antenna. In operation 805, the electronic device 101 may receive a response message using the first antenna. In operation 807, the electronic device 101 may identify a first distance between the electronic device 101 and the external electronic device 200. For example, the electronic device 101 may identify the first distance based on the difference (e.g., T1) between a transmission time of the poll message and a reception time of the response message, and a process time (e.g., T2) of the external electronic device 200.

According to various embodiments, in operation 809, the electronic device 101 may control the switching state of the first antenna to a second state based on first and second orientations. The electronic device 101 may identify the switching state (e.g., antenna setting) of the first antenna based on the difference between the first orientation and the second orientation and the association information shown in Table 1, for example. The antenna settings in Table 1 may be replaced with antenna switching states. After controlling the switching state of the first antenna to the second state, the electronic device 101 may transmit a poll message using the first antenna in operation 811. In operation 813, the electronic device 101 may receive a response message using the first antenna. In operation 815, the electronic device 101 may identify a second distance between the electronic device 101 and the external electronic device 200. For example, the electronic device 101 may identify the second distance based on the difference (e.g., T3) between a transmission time of the poll message and a reception time of the response message, and a process time (e.g., T4) of the external electronic device 200. Although the second distance may be different from the first distance, they may be the same within a tolerance range under circumstances. Even if the second distance is equal to the first distance within the tolerance range, the maximum measurable distance of the electronic device 101 may increase. Accordingly, even if the distance between the electronic device 101 and the external electronic device 200 increases later, the electronic device 101 may track the position of the external electronic device 200.

FIG. 9 is a diagram illustrating an antenna switching state according to a difference in orientation between an electronic device and an external electronic device according to an embodiment of the disclosure.

According to various embodiments, the electronic device 101 may include the antenna 301, and the external electronic device 200 may include the antenna 311. The electronic device 101 may identify that the orientation of the electronic device 101 is 90° based on data from the sensor module 176 of the electronic device 101. The external electronic device 200 may identify that the orientation of the external electronic device 200 is 180° based on data from the sensor module 452 of the external electronic device 200. The external electronic device 200 may transmit a communication signal including information about 180°, which is the orientation of the external electronic device 200, to the electronic device 101 based on the first communication scheme (e.g., BLE communication). The electronic device 101 may identify that a difference 901 between the 180° orientation of the external electronic device 200 identified based on the received communication signal and the determined orientation of the electronic device 101 is 90°.

Referring to FIG. 9, the electronic device 101 may store a lookup table indicating that an antenna switching state, ANT SW State is a first state for the orientation difference of 45° and a second state for the orientation difference of 90°. The electronic device 101 may identify that an antenna switching state corresponding to the identified orientation difference 901 of 90° is the second state by referring to the lookup table. The electronic device 101 may control the antenna switching state to the identified second state.

In another example, the external electronic device 200 may identify that the orientation of the external electronic device 200 is 45° based on data from the sensor module 452 of the external electronic device 200. The external electronic device 200 may transmit a communication signal including information about 45°, which is the orientation of the external electronic device 200, to the electronic device 101 based on the first communication scheme (e.g., BLE communication). The electronic device 101 may identify that a difference 902 between the 45° orientation of the external electronic device 200 identified based on the received communication signal and the orientation of the electronic device 101 is 45°. The electronic device 101 may identify that the antenna switching state corresponding to the identified orientation difference 902 of 45° is the first state by referring to the lookup table. The electronic device 101 may control the antenna switching state to the first state.

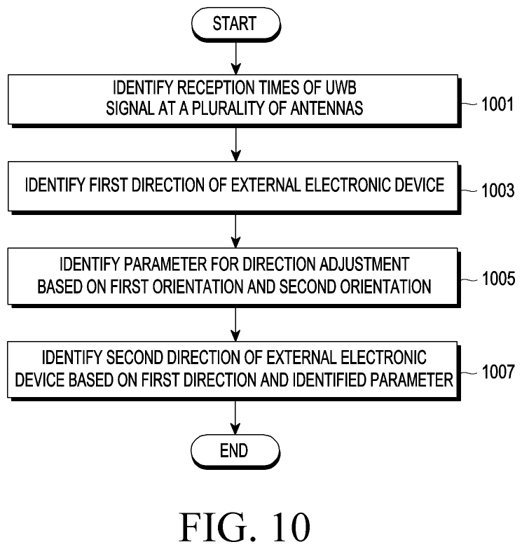

FIG. 10 is a flowchart illustrating a method of operating an electronic device according to an embodiment of the disclosure.

According to various embodiments, the electronic device 101 (e.g., the processor 120 and/or the second communication module 420) may identify reception times (or reception phases) of a UWB signal at a plurality of antennas for direction measurement in operation 1001. The external electronic device 200 may transmit the UWB signal, and each of the plurality of antennas of the electronic device 101 may measure the UWB signal. Depending on an antenna spacing between the plurality of antennas, the reception time (e.g., measurement time) and/or reception phase of the UWB signal may be different at each of the plurality of antennas.

Referring to FIG. 10, in operation 1003, the electronic device 101 may identify a first direction of the external electronic device 200. The electronic device 101 may identify the first direction of the external electronic device 200 based on the reception time (e.g., measurement time) and/or reception phase of the UWB signal at each of the plurality of antennas.

According to various embodiments, the electronic device 101 may identify a parameter (e.g., offset) for direction adjustment based on a first orientation of the electronic device 101 and a second orientation of the external electronic device 200 in operation 1005. The electronic device 101 may receive information about the second orientation of the external electronic device 200 using the first communication scheme (e.g., BLE communication) different from the UWB communication scheme. The electronic device 101 may store, for example, association information between orientation differences between the electronic device 101 and the external electronic device 200 and parameters (e.g., offsets) corresponding to the orientation differences. Table 2 is an example of the association information.

TABLE 2

| Orientation difference | Offset |
|---|---|
| 0° or above to 45° or below | First value |
| 45° or above to 90° or below | Second value |
| 90° or above to 135° or below | Third value |
| 135° or above to 180° or below | Fourth value |

For example, Table 2 is an example of a case in which each of the orientations of the electronic device 101 and the external electronic device 200 is expressed as a one-dimensional angle, and those skilled in the art will understand that the dimension corresponding to the orientation differences in the association information of Table 1 is not limited, and may depend on the dimension in which the orientations are expressed. Those skilled in the art will also understand that representation of the differences in orientation as ranges in Table 2 is also exemplary, and the ranges may be replaced with specified values. For example, the electronic device 101 may identify that the first orientation of the electronic device 101 is 90°, and the second orientation of the external electronic device 200 is 30°. The electronic device 101 may identify the difference between the first orientation and the second orientation as 90°-30°, that is, 60°. The electronic device 101 may identify that an offset corresponding to the difference is a second value based on the association information, for example, as shown in Table 2. According to various embodiments, the electronic device 101 may identify a second direction of the external electronic device based on the first direction and the identified parameter in operation 1007. For example, the electronic device 101 may identify a first angle α1 as the first direction based on information related to reception of a UWB signal. The electronic device 101 may apply the parameter (e.g., the offset of the “second value”) identified based on the orientation difference to the first angle α1 that is the first direction. In an example, when the electronic device 101 identifies that the direction in which the external electronic device 200 is located is 5° based on the information related to reception of the UWB signal, and the offset based on the orientation difference is +15°, the electronic device 101 may identify a direction of 20° obtained by adding 15° to 5° as the direction in which the external electronic device 200 is located. In an example, although the electronic device 101 may identify the second direction by adding the second value to the first angle α1, adding the offset is simply illustrative, and the formula for correction is not limited.

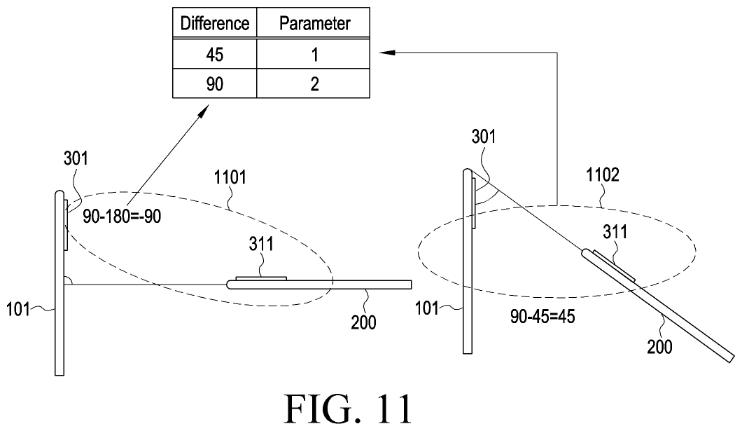

FIG. 11 is a diagram illustrating parameter application based on a difference in orientation between an electronic device and an external electronic device according to an embodiment of the disclosure.

According to various embodiments, the electronic device 101 may include the antenna 301, and the external electronic device 200 may include the antenna 311. The electronic device 101 may identify that the orientation of the electronic device 101 is 90° based on data from the sensor module 176 of the electronic device 101. The external electronic device 200 may identify that the orientation of the external electronic device 200 is 180° based on data from the sensor module 452 of the external electronic device 200. The external electronic device 200 may transmit a communication signal including information about 180°, which is the orientation of the external electronic device 200, to the electronic device 101 based on the first communication scheme (e.g., BLE communication). The electronic device 101 may identify that a difference 1101 between the 180° orientation of the external electronic device 200 identified based on the received communication signal and the orientation of the electronic device 101 is 90°. Referring to FIG. 11, the electronic device 101 may store a lookup table indicating that a parameter to be applied is a first parameter for an orientation difference of 45° is a first parameter and a second parameter for an orientation difference of 90°. The electronic device 101 may identify that the parameter corresponding to the identified orientation difference 1101 of 90° is the second parameter by referring to the lookup table. The electronic device 101 may identify a corrected direction by applying the second parameter to the direction of the external electronic device 200 identified based on the processing of the UWB signal.

In another example, the external electronic device 200 may identify that the orientation of the external electronic device 200 is 45° based on data from the sensor module 452 of the external electronic device 200. The external electronic device 200 may transmit a communication signal including information about 45°, which is the orientation of the external electronic device 200, to the electronic device 101 based on the first communication scheme (e.g., BLE communication). The electronic device 101 may identify that a difference 1102 between the 45° orientation of the external electronic device 200 identified based on the received communication signal and the orientation of the electronic device 101 is 45°. The electronic device 101 may identify that the parameter corresponding to the identified orientation difference 1102 of 45° is the first parameter by referring to the lookup table. The electronic device 101 may identify a corrected direction by applying the second parameter to the direction of the external electronic device 200 identified based on the processing of the UWB signal.

An offset for a finally identified direction has been described above as an example of a parameter for correcting the direction of the external electronic device 200. In another example, the electronic device 101 may identify a phase shift of a received UWB signal at each of a plurality of antennas as a parameter for direction adjustment. As described with reference to FIG. 4B, the patch antennas 422, 423, and 424 may receive the communication signal 465 based on UWB communication from the external electronic device 200. The second communication module 420 may further include phase shifters (not shown) for shifting the phases of RF signals from the patch antennas 422, 423, and 424. The electronic device 101 may determine (or select from a lookup table) a phase shift degree of each of the phase shifters based on the orientation of the electronic device 101 and the orientation of the external electronic device 200. When an additional UWB signal is received later, the electronic device 101 may control the phase shifters to perform shifting by the determined phase shift degrees.

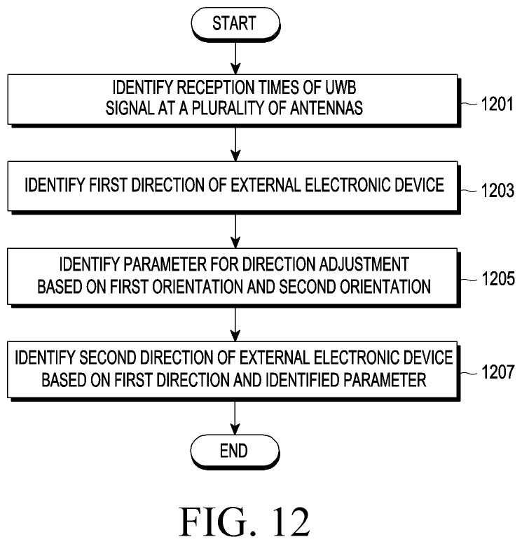

FIG. 12 is a flowchart illustrating a method of operating an electronic device according to an embodiment of the disclosure.

According to various embodiments, the electronic device 101 (e.g., the processor 120 and/or the second communication module 420) may identify reception times (or reception phases) of a UWB signal at a plurality of antennas for direction measurement in operation 1201. In operation 1203, the electronic device 101 may identify a first direction of the external electronic device 200. The electronic device 101 may identify the first direction of the external electronic device 200 based on the reception times (e.g., measurement times) and/or reception phases of the UWB signal at the plurality of antennas.

Referring to FIG. 12, in operation 1205, the electronic device 101 may identify a parameter (e.g., offset) for direction adjustment based on a first orientation of the electronic device 101 and a second orientation of the external electronic device 200. The electronic device 101 may receive information about the second orientation of the external electronic device 200 based on the first communication scheme (e.g., BLE communication) different from the UWB communication scheme. The electronic device 101 may store association information between differences in orientation between the electronic device 101 and the external electronic device 200 and determined directions of the external electronic device 200 and parameters (e.g., offsets) corresponding to the orientation differences and the directions. Table 3 is an example of the association information.

TABLE 3

| | Direction of | |
|---|---|---|
| Orientation difference | external device | Offset |
| 0° or above to 45° or below | First range | First value |
| | Second range | Second value |
| 45° or above to 90° or below | First range | Third value |
| | Second range | Fourth value |
| 90° or above to 135° or below | First range | Fifth value |
| | Second range | Sixth value |
| 135° or above to 180° or below | First range | Seventh value |
| | Second range | Eighth value |

For example, Table 3 is an example of a case in which the orientations of the electronic device 101 and the external electronic device 200 are each expressed as a one-dimensional angle, and those skilled in the art will understand that the dimension corresponding to the orientation differences in the association information of Table 1 is not limited, and may depend on the dimension in which the orientations are expressed. Further, although the directions of the external device are expressed as a first range and a second range in Table 3, and the number of ranges of the directions of the external device is not limited. Further, those skilled in the art will also understand that representation of the orientation differences and the directions of the external device as ranges in Table 3 is also illustrative, and the ranges may be replaced with specified values. For example, the electronic device 101 may identify that the first orientation of the electronic device 101 is 90°, and the second orientation of the external electronic device 200 is 30°. The electronic device 101 may identify the difference between the first orientation and the second orientation as 90°-30°, that is, 60°. In addition, the electronic device 101 may identify that the direction of the external electronic device identified in operation 1203 belongs to the second range. For example, the electronic device 101 may identify that an offset corresponding to the orientation difference and the direction of the external electronic device 200 is a fourth value, for example, based on the association information as shown in Table 3. According to various embodiments, in operation 1207, the electronic device 101 may identify a second direction of the external electronic device based on the first direction and the identified parameter. For example, the electronic device 101 may identify a first angle α1 as the first direction based on information related to reception of a UWB signal. The electronic device 101 may apply the parameter (e.g., the offset of the “fourth value”) identified based on the difference in orientation to the first angle α1 as the first direction. In an example, when the electronic device 101 identifies that the direction in which the external electronic device 200 is located is 5° based on the information related to reception of the UWB signal, and the offset based on the difference in orientation is +35°, the electronic device 101 may identify the direction of 40° obtained by adding 35° to 5° as the direction in which the external electronic device 200 is located. In an example, although the electronic device 101 may identify the second direction by adding the fourth value to the first angle α1, adding the offset is simply illustrative, and the formula for correction is not limited.

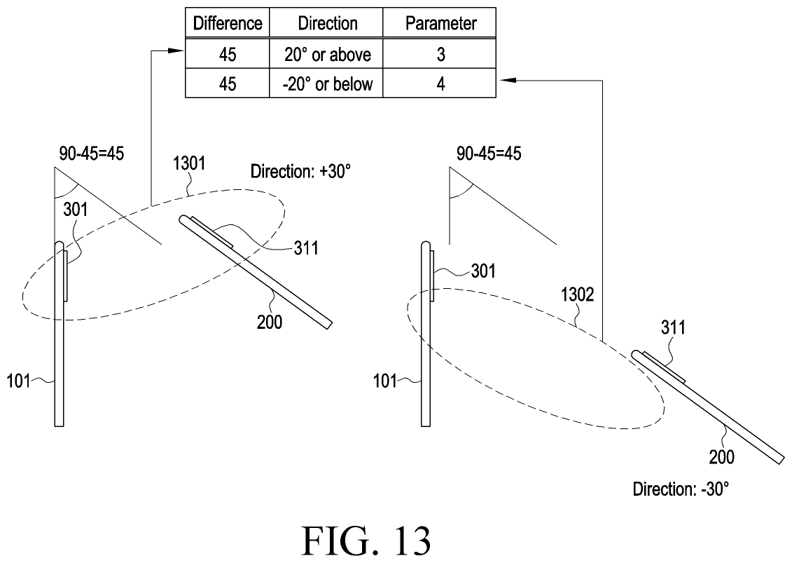

FIG. 13 is a diagram illustrating parameter application according to a difference in orientation between an electronic device and an external electronic device according to an embodiment of the disclosure.

According to various embodiments, the electronic device 101 may include the antenna 301, and the external electronic device 200 may include the antenna 311. The electronic device 101 may identify that the orientation of the electronic device 101 is 90° based on data from the sensor module 176 of the electronic device 101. The external electronic device 200 may identify that the orientation of the external electronic device 200 is 45° based on data from the sensor module 452 of the external electronic device 200. The external electronic device 200 may transmit a communication signal including information about 45°, which is the orientation of the external electronic device 200, to the electronic device 101 based on the first communication scheme (e.g., BLE communication). The electronic device 101 may identify that the difference between the orientation of the external electronic device 200 and the orientation of the electronic device 101 is 45° based on the received communication signal. In addition, the electronic device 101 may identify that a direction in which the external electronic device 200 is located is +30° based on an AOA scheme.

Referring to FIG. 13, the electronic device 101 may store a lookup table indicating a third parameter to be applied when the orientation difference is 45° and the direction of the external electronic device 200 is +20° or more, and a fourth parameter to be applied when the orientation difference is 45° and the direction of the external electronic device 200 is −20° or less. The electronic device 101 may identify that a parameter corresponding to the identified orientation difference of 45° and a direction 1301 of +30° is the third parameter by referring to the lookup table. The electronic device 101 may identify a corrected direction by applying the third parameter to the direction of the external electronic device 200 identified based on the processing of the UWB signal.

In another example, as the external electronic device 200 identifies that the difference between the 45° orientation of the external electronic device 200 and the orientation of the electronic device 101 is 45°, it may identify that the direction of the external electronic device 200 is −30°. The electronic device 101 may identify that a parameter corresponding to the identified orientation difference of 45° and a direction 1302 of −30° is the fourth parameter by referring to the lookup table. The electronic device 101 may identify a corrected direction by applying the fourth parameter to the direction of the external electronic device 200 identified based on the processing of the UWB signal.

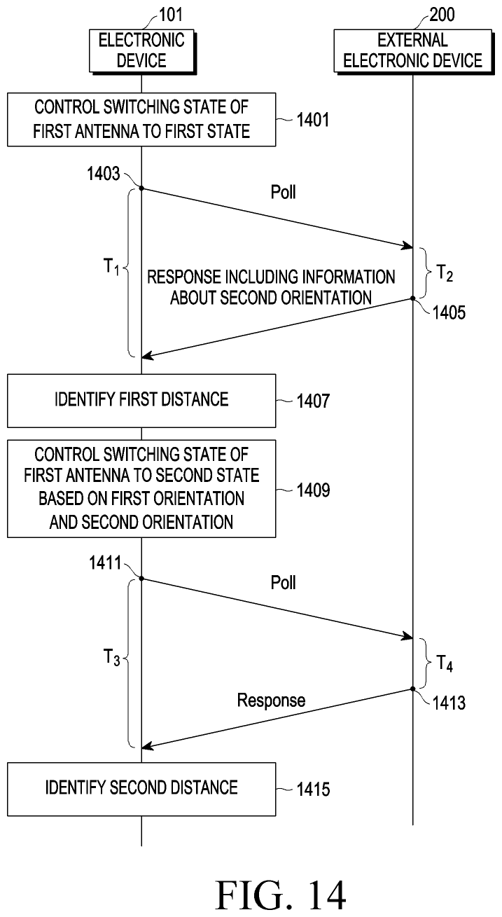

FIG. 14 is a flowchart illustrating a method of operating an electronic device according to an embodiment of the disclosure.

According to various embodiments, the electronic device 101 (e.g., the processor 120 and/or the second communication module 420) may control the switching state of a first antenna for the second communication scheme (e.g., UWB communication) to a first state in operation 1401.

Referring to FIG. 14, in operation 1403, the electronic device 101 may transmit a poll message. In operation 1405, the electronic device 101 may receive a response message including information about a second orientation of the external electronic device 200. As described above, the external electronic device 200 may identify the orientation of the external electronic device 200 based on data from the sensor module 452. The external electronic device 200 may transmit a response message including orientation information based on the second communication scheme (e.g., UWB communication). In operation 1407, a first distance between the electronic device 101 and the external electronic device 200 may be identified. For example, the electronic device 101 may identify the first distance based on the difference (e.g., T1) between a transmission time of the poll message and a reception time of the response message, and a process time (e.g., T2) of the external electronic device 200.

According to various embodiments, in operation 1409, the electronic device 101 may control the switching state of the first antenna to a second state based on first and second orientations. The electronic device 101 may identify the second orientation included in the response message, and thus control the switching state of the first antenna based on the first orientation and the second orientation. For example, the electronic device 101 may identify the switching state (e.g., antenna setting) of the first antenna based on the difference between the first orientation and the second orientation and the association information shown in Table 1. After controlling the switching state of the first antenna to the second state, the electronic device 101 may transmit a poll message using the first antenna in operation 1411. In operation 1413, the electronic device 101 may receive a response message using the first antenna. In operation 1415, the electronic device 101 may identify a second distance between the electronic device 101 and the external electronic device 200. For example, the electronic device 101 may identify the second distance based on the difference (e.g., T3) between a transmission time of the poll message and a reception time of the response message, and a process time (e.g., T4) of the external electronic device 200.

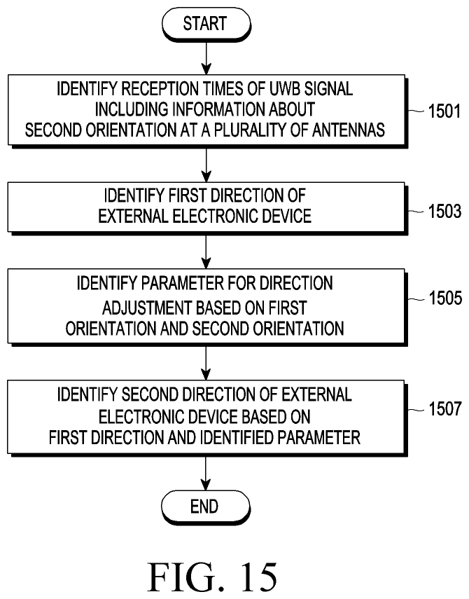

FIG. 15 is a flowchart illustrating a method of operating an electronic device according to an embodiment of the disclosure.

According to various embodiments, the electronic device 101 (e.g., the processor 120 and/or the second communication module 420) may identify reception times (or reception phases) of a UWB signal at a plurality of antennas for direction measurement in operation 1501. The external electronic device 200 may transmit a UWB signal including information about a second orientation of the external electronic device 200. The UWB signal may be measured at each of the plurality of antennas of the electronic device 101. Depending on an antenna spacing between the plurality of antennas, the reception time (e.g., measurement time) and/or reception phase of the UWB signal may be different at each of the plurality of antennas.

Referring to FIG. 15, in operation 1503, the electronic device 101 may identify a first direction of the external electronic device 200. The electronic device 101 may identify the first direction of the external electronic device 200 based on the reception time (e.g., measurement time) and/or reception phase of the UWB signal at each of the plurality of antennas.

According to various embodiments, the electronic device 101 may identify a parameter (e.g., offset) for direction adjustment based on a first orientation of the electronic device 101 and a second orientation of the external electronic device 200 in operation 1505. The electronic device 101 may identify an offset corresponding to the difference based on, for example, the association information shown in Table 2. In operation 1507, the electronic device 101 may identify a second direction of the external electronic device based on the first direction and the identified parameter.

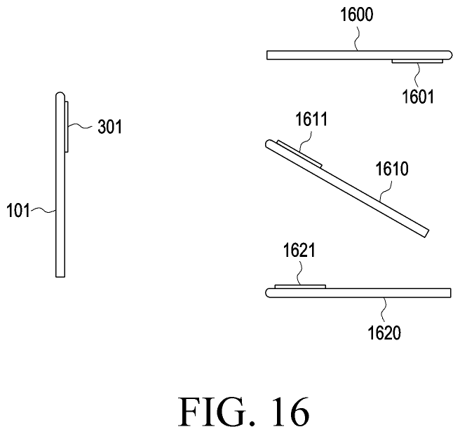

FIG. 16 is a diagram illustrating an electronic device that communicates with a plurality of external electronic devices according to an embodiment of the disclosure.

According to various embodiments, the electronic device 101 (e.g., the processor 120 and/or the second communication module 420) may transmit and receive communication signals based the second communication scheme (e.g., UWB communication) to and from a plurality of external electronic devices 1600, 1610, and 1620. The plurality of external electronic devices 1600, 1610, and 1620 may include antennas 1601, 1611, and 1621 for the second communication scheme, respectively. Although not shown, each of the plurality of external electronic devices 1600, 1610, and 1620 may include an antenna for supporting the first communication scheme (e.g., BLE communication).

Referring to FIG. 16, the electronic device 101 may be disposed with a first orientation, the first external electronic device 1600 may be disposed with a second orientation, the second external electronic device 1610 may disposed with a third orientation, and the third external electronic device 1620 may be disposed with a fourth orientation. The electronic device 101 may receive orientation information from the external electronic devices 1600, 1610, and 1620, respectively, based on the first communication scheme. As shown in Table 4, the electronic device 101 may manage information about the plurality of external electronic devices 1600, 1610, and 1620.

TABLE 4

| | | | | | Corrected | Antenna | Corrected |
|---|---|---|---|---|---|---|---|
| BLE | | Direction | Distance | | direction | switching | distance |
| Address | Orientation | (°) | (m) | Parameter | (°) | state | (m) |
| 0 × A1 | Second | 30 | 1 | First | 25 | First state | 1 |
| | orientation | | | parameter | | | |
| 0 × B1 | Third | 10 | 0.5 | Second | 3 | Second | 10.4 |
| | orientation | | | parameter | | state | |
| 0 × C1 | Fourth | −30 | 1.5 | Third | −28 | Third state | 1.5 |
| | orientation | | | parameter | | | |

The information managed in Table 4 is merely exemplary. At least some of managed information items may be excluded, and other items may be further added. As shown in Table 4, the electronic device 101 may identify the external electronic devices 1600, 1610, and 1620 by BLE addresses. The BLE addresses are merely illustrative, and any information may substitute for the BLE addresses and/or may be used additionally, as far as it identifies the external electronic devices. The electronic device 101 may identify the orientation of each of the external electronic devices 1600, 1610, and 1620 based on information included in a BLE communication signal corresponding to a BLE address. The electronic device 101 may identify directions (e.g., 30°, 0°, and −30°) and distances (e.g., 1 m, 0.5 m, and 1.5 m) corresponding to the respective external electronic devices 1600, 1610 and 1620 based on at least one UWB signal from each of the external electronic devices 1600, 1610 and 1620. According to various embodiments, the electronic device 101 may identify the differences between the orientation (e.g., a first orientation) of the electronic device 101 and the orientations (e.g., a second orientation, a third orientation, and a fourth orientation) of the external electronic devices 1600, 1610, and 1620. The electronic device 101 may identify parameters (e.g., a first parameter, a second parameter, and a third parameter) for direction correction for the respective external electronic devices (e.g., the respective BLE addresses) based on the orientation differences. The electronic device 101 may identify corrected directions (e.g., 25°, 3°, and −28°) by applying the identified parameters to the already identified directions. In the example of Table 4, the first parameter may be, for example, an offset of −5°, the second parameter may be an offset of +3°, and the third parameter may be an offset of +2°. The electronic device 101 may identify an antenna switching state (e.g., a first state, a second state, or a third state) for each external electronic device (e.g., each BLE address) based on the orientation differences. After controlling the external electronic devices 1600, 1610, and 1620 to the identified antenna switching states in time division, the electronic device 101 may receive UWB signals and identify corrected distances (e.g., e.g., 1 m, 0.4 m, and 1.5 m) based on the UWB signals. The corrected distances may be different from or the same as previously identified distances. Even if the corrected distances are the same, the maximum measurable distance of the electronic device 101 in the corresponding antenna switching states has increased, compared to the previous case, thereby increasing the tracking possibility of the external electronic devices. For example, the electronic device 101 may control the switching state of an antenna to the first state when transmitting and receiving UWB signals to and from the first external electronic device 1600, to the second state when transmitting and receiving UWB signals to and from the second external electronic device 1610, and to the third state when transmitting and receiving UWB signals to and from the third external electronic device 1620. Alternatively, the electronic device 101 may select any one of the first state, the second state, and the third state and control the switching state of the antenna to the selected state. For example, the electronic device 101 may control the switching state of the antenna to the third state corresponding to the third external electronic device 1620 determined to be farthest. However, a selection method is not limited. Alternatively, the electronic device 101 may determine the switching state of the antenna based on a combination of the orientations of the external electronic devices 1600, 1610, and 1620. In another example, the electronic device 101 may use a single correction parameter (e.g., offset) for the external electronic devices 1600, 1610, and 1620. For example, the electronic device 101 may predict an error and use a single correction parameter that leads to a smallest error value. Each of the external electronic devices 1600, 1610, and 1620 may also receive information about the orientation of the electronic device 101 based on the first communication scheme (e.g., BLE communication) from the electronic device 101. Each of the external electronic devices 1600, 1610, and 1620 may identify the difference between its orientation and the orientation of the electronic device 101. Each of the external electronic devices 1600, 1610, and 1620 may control the switching state of an antenna based on the identified difference. Each of the external electronic devices 1600, 1610, and 1620 may identify a parameter for direction correction based on the identified orientation difference. Each of the external electronic devices 1600, 1610, and 1620 may identify the direction of the electronic device 101 with respect to the external electronic device, based on reception characteristics of a communication signal of the second communication scheme (e.g., UWB communication) transmitted from the electronic device 101. Each of the external electronic devices 1600, 1610, and 1620 may identify a corrected direction of the electronic device 101 by applying a parameter identified based on the orientation difference to the identified direction of the electronic device 101. The electronic device 101 and the external electronic devices 1600, 1610, and 1620 may exchange information about the distances and/or directions of their other devices with each other.

According to various embodiments, the electronic device 101 may manage the position and identification information of each of the plurality of external electronic devices 1600, 1610, and 1620, as shown in Table 4, for example. The electronic device 101 may assign UWB identification information (e.g., a UWB preamble ID) to each of the plurality of external electronic devices 1600, 1610, and 1620. The electronic device 101 and/or the external electronic devices 1600, 1610, and 1620 may generate UWB identification information during set-up of a UWB session and manage the UWB identification information in association with BLE identification information. For example, the electronic device 101 may manage first BLE identification information and first UWB identification information in association with each other, for the first external electronic device 1600. The electronic device 101 may receive a UWB signal associated with the first UWB identification information and may identify the distance and/or direction of the first external electronic device 1600 based on the UWB signal. The electronic device 101 may receive a BLE signal associated with the first BLE identification information and identify orientation information about the first external electronic device 1600 from the BLE signal. The electronic device 101 may identify the first parameter and the first state based on orientation information about the electronic device 101 and the orientation information about the first external electronic device 1600. The electronic device 101 may identify a corrected direction by applying the first parameter to the direction of the first external electronic device 1600 corresponding to the first UWB identification information. In addition, the electronic device 101 may set an antenna setting to the first state to transmit and receive UWB signals to and from the first external electronic device 1600. In another example, the electronic device 101 may manage the orientations of the external electronic devices 1600, 1610, and 1620 in correspondence with the BLE identification information. For example, the electronic device 101 may identify a position based on a UWB signal from the first external electronic device 1600, and identify an external electronic device corresponding to the position as the first external electronic device 1600. The electronic device 101 may identify an external electronic device corresponding to a position closest to a newly identified position among the positions of a plurality of existing external electronic devices under management. The electronic device 101 may perform correction for the newly identified position by using the orientation of the corresponding external electronic device.

According to various embodiments, an electronic device (e.g., the electronic device 101) may include at least one sensor (e.g., the sensor module 176), a first communication module (e.g., the first communication module 410) configured to support a first communication scheme, and a second communication module (e.g., the second communication module 420) configured to support a second communication scheme. The first communication module (e.g., the first communication module 410) may be further configured to transmit a signal for discovery of an external electronic device (e.g., the external electronic device 200) configured to support the second communication scheme, and receive a first response signal to the signal for discovery, transmitted by the external electronic device (e.g., the external electronic device 200), and the second communication module (e.g., the second communication module 420) may be further configured to perform at least one first operation for identifying a position of the external electronic device (e.g., the external electronic device 200), based on identification that the external electronic device (e.g., the external electronic device 200) supports the second communication scheme based on the first response signal, and perform at least one second operation for adjusting the position of the external electronic device (e.g., the external electronic device 200), based on a first orientation of the electronic device (e.g., the electronic device 101) identified based on the at least one sensor (e.g., the sensor module 176), and based on a second orientation of the external electronic device (e.g., the external electronic device 200) obtained through the first communication module (e.g., the first communication module 410).

According to various embodiments, as at least a part of performing the at least one first operation for identifying the position of the external electronic device (e.g., the external electronic device 200), the second communication module (e.g., the second communication module 420) may be further configured to transmit a first communication signal based on the second communication scheme, receive a second communication signal based on the second communication scheme, corresponding to the first communication signal, and identify a distance between the electronic device (e.g. the electronic device 101) and the external electronic device (e.g., the external electronic device 200) based on a transmission time of the first communication signal, a reception time of the second communication signal, and a process time of the external electronic device (e.g., the external electronic device 200).

According to various embodiments, as at least a part of performing the at least one second operation for adjusting the position of the external electronic device (e.g., the external electronic device 200), the second communication module (e.g., the second communication module 420) may be further configured to adjust an antenna characteristic of at least some of at least one antenna (e.g., the antennas 421, 422, 423, and 424) for at least one of transmitting the first communication signal or receiving the second communication signal based on the first orientation and the second orientation.

According to various embodiments, the second communication module (e.g., second communication module 420) may include a switch selectively connecting at least one of a plurality of stubs corresponding to the at least some of the at least one antenna (e.g., the antennas 421, 422, 423, and 424) to the at least some of the at least one antenna. As at least a part of adjusting the antenna characteristic of the at least some of the at least one antenna (e.g., the antennas 421, 422, 423, and 424), based on the first orientation and the second orientation, the second communication module (e.g., the second communication module 420) may be further configured to select at least one of the plurality of stubs based on the first orientation and the second orientation, and control the switch to connect the selected stub to the at least some of the at least one antenna (e.g., the antennas 421, 422, 423, and 424).

According to various embodiments, the second communication module (e.g., the second communication module 420) may include a switch selectively connecting at least one of a plurality of elements corresponding to the at least some of the at least one antenna (e.g., the antennas 421, 422, 423, and 424) to the at least some of the at least one antenna (e.g., the antennas 421, 422, 423, and 424). As at least a part of adjusting the antenna characteristic of the at least some of the at least one antenna (e.g., the antennas 421, 422, 423, and 424), based on the first orientation and the second orientation, the second communication module (e.g., the second communication module 420) may be further configured to select at least one of the plurality of elements based on the first orientation and the second orientation, and control the switch to connect the selected element to the at least some of the at least one antenna (e.g., the antennas 421, 422, 423, and 424).

According to various embodiments, after adjusting the characteristic of at least some of the at least one antenna (e.g., the antennas 421, 422, 423, and 424) for at least one of transmitting the first communication signal or receiving the second communication signal based on the first orientation and the second orientation, the second communication module (e.g., the second communication module 420) may be further configured to transmit a third communication signal based on the second communication scheme, receive a fourth communication signal based on the second communication scheme, corresponding to the third communication signal, and identify a distance between the electronic device (e.g., the electronic device 101) and the external electronic device (e.g., the external electronic device 200) based on a transmission time of the third communication signal, a reception time of the fourth communication signal, and a process time of the external electronic device (e.g., the external electronic device 200).

According to various embodiments, as at least a part of performing the at least one first operation for identifying the position of the external electronic device (e.g., the external electronic device 200), the second communication module (e.g., the second communication module 420) may be further configured to receive a fifth communication signal based on the second communication scheme from the external electronic device (e.g., the external electronic device 200) through a plurality of antennas (e.g., the patch antennas 422, 423, and 424) of the second communication module (e.g., the second communication module 420), and identify a direction of the external electronic device (e.g., the external electronic device 200) with respect to the electronic device (e.g., the electronic device 101), based on a difference in reception characteristics of the fifth communication signal at each of the plurality of respective antennas (e.g., the patch antennas 422, 423, and 424).

According to various embodiments, as at least a part of performing the at least one second operation for adjusting the position of the external electronic device (e.g., the external electronic device 200), the second communication module (e.g., the second communication module 420) may be further configured to identify at least one parameter for correcting the direction of the external electronic device (e.g., the external electronic device 200), based on the first orientation and the second orientation, and correct the direction of the external electronic device (e.g., the external electronic device 200) by applying the at least one parameter to the direction of the external electronic device (e.g., the external electronic device 200).

According to various embodiments, as at least part of performing the at least one second operation for adjusting the position of the external electronic device (e.g., the external electronic device 200), the second communication module (e.g., the second communication module 420) may be further configured to identify at least one parameter for correcting the direction of the external electronic device (e.g., the external electronic device 200) based on the direction of the external electronic device (e.g., the external electronic device 200), the first orientation, and the second orientation, and correct the direction of the external electronic device (e.g., the external electronic device 200) by applying the at least one parameter to the direction of the external electronic device (e.g., the external electronic device 200).

According to various embodiments, the first communication module (e.g., the first communication module 410) may be further configured to transmit a communication signal including the first orientation of the electronic device (e.g., the electronic device 101) to the external electronic device (e.g., the external electronic device 200), and request adjustment of a position of the electronic device (e.g., the electronic device 101) identified by the external electronic device (e.g., the external electronic device 200), based on the first orientation and the second orientation.

According to various embodiments, a method performed by an electronic device (e.g., the electronic device 101) including at least one sensor (e.g., the sensor module 176), a first communication module (e.g., the first communication module 410) configured to support a first communication scheme, and a second communication module (e.g., the second communication module 420) configured to support a second communication scheme may include transmitting a signal for discovery of an external electronic device (e.g., the external electronic device 200) configured to support the second communication scheme by the first communication module (e.g., the first communication module 410), receiving a first response signal to the signal for discovery, transmitted by the external electronic device (e.g., the external electronic device 200), by the first communication module (e.g., the first communication module 410), performing at least one first operation for identifying a position of the external electronic device (e.g., the external electronic device 200) based on identification that the external electronic device (e.g., the external electronic device 200) supports the second communication scheme based on the first response signal by the second communication module (e.g., the second communication module 420), and performing at least one second operation for adjusting the position of the external electronic device (e.g., the external electronic device 200) based on a first orientation of the electronic device (e.g., the electronic device 101) identified based on the at least one sensor (e.g., the sensor module 176), and based on a second orientation of the external electronic device (e.g., the external electronic device 200) obtained through the first communication module (e.g., the first communication module 410), by the second communication module (e.g., the second communication module 420).

According to various embodiments, performing the at least one first operation for identifying the position of the external electronic device (e.g., the external electronic device 200) by the second communication module (e.g., the second communication module 420) may include transmitting a first communication signal based on the second communication scheme by the second communication module (e.g., the second communication module 420), receiving a second communication signal based on the second communication scheme, corresponding to the first communication signal by the second communication module (e.g., the second communication module 420), and identifying a distance between the electronic device (e.g., the electronic device 101) and the external electronic device (e.g., the external electronic device 200) based on a transmission time of the first communication signal, a reception time of the second communication signal, and a process time of the external electronic device (e.g., the external electronic device 200).

According to various embodiments, performing the at least one second operation for adjusting the position of the external electronic device (e.g., the external electronic device 200) by the second communication module (e.g., the second communication module 420) may include adjusting an antenna characteristic of at least some of at least one antenna (e.g., the antennas 421, 422, 423, and 424) for at least one of transmitting the first communication signal or receiving the second communication signal, based on the first orientation and the second orientation.

According to various embodiments, the second communication module (e.g., the second communication module 420) may include a switch selectively connecting at least one of a plurality of stubs corresponding to the at least some of the at least one antenna (e.g., the antennas 421, 422, 423, and 424) to the at least some of the at least one antenna. Adjusting the antenna characteristic of the at least some of the at least one antenna (e.g., the antennas 421, 422, 423, and 424), based on the first orientation and the second orientation by the second communication module (e.g., the second communication module 420) may include selecting at least one of the plurality of stubs based on the first orientation and the second orientation, and controlling the switch to connect the selected stub to the at least some of the at least one antenna (e.g., the antennas 421, 422, 423, and 424).

According to various embodiments, the second communication module (e.g., the second communication module 420) may include a switch configured to selectively connect at least one of a plurality of elements corresponding to the at least some of the at least one antenna (e.g., the antennas 421, 422, 423, and 424) to the at least some of the at least one antenna. Adjusting the antenna characteristic of the at least some of the at least one antenna (e.g., the antennas 421, 422, 423, and 424) based on the first orientation and the second orientation by the second communication module (e.g., the second communication module 420) may include selecting at least one of the plurality of elements based on the first orientation and the second orientation, and controlling the switch to connect the selected element to the at least some of the at least one antenna (e.g., the antennas 421, 422, 423, and 424).

According to various embodiments, the method may further include, after adjusting the characteristic of at least some of the at least one antenna (e.g., the antennas 421, 422, 423, and 424) for transmitting the first communication signal and/or receiving the second communication signal based on the first orientation and the second orientation, transmitting a third communication signal based on the second communication scheme by the second communication module (e.g., the second communication module 420), receiving a fourth communication signal based on the second communication scheme, corresponding to the third communication signal, and identifying a distance between the electronic device (e.g., the electronic device 101) and the external electronic device (e.g., the external electronic device 200) based on a transmission time of the third communication signal, a reception time of the fourth communication signal, and a process time of the external electronic device (e.g., the external electronic device 200).

According to various embodiments, performing the at least one first operation for identifying the position of the external electronic device (e.g., the external electronic device 200) by the second communication module (e.g., the second communication module 420) may include receiving a fifth communication signal based on the second communication scheme from the external electronic device (e.g., the external electronic device 200) through a plurality of antennas (e.g., the patch antennas 422, 423, and 424) of the second communication module (e.g., the second communication module 420), and identifying a direction of the external electronic device (e.g., the external electronic device 200) with respect to the electronic device (e.g., the electronic device 101) based on a difference in reception characteristics of the fifth communication signal at each of the plurality of respective antennas (e.g., the patch antennas 422, 423, and 424).

According to various embodiments, performing the at least one second operation for adjusting the position of the external electronic device (e.g., the external electronic device 200) by the second communication module (e.g., the second communication module 420) may include identifying at least one parameter for correcting the direction of the external electronic device (e.g., the external electronic device 200) based on the first orientation and the second orientation, and correcting the direction of the external electronic device (e.g., the external electronic device 200) by applying the at least one parameter to the direction of the external electronic device (e.g., the external electronic device 200).

According to various embodiments, performing the at least one second operation for adjusting the position of the external electronic device (e.g., the external electronic device 200) by the second communication module (e.g., the second communication module 420) may include identifying at least one parameter for correcting the direction of the external electronic device (e.g., the external electronic device 200) based on the direction of the external electronic device (e.g., the external electronic device 200), the first orientation, and the second orientation, and correcting the direction of the external electronic device (e.g., the external electronic device 200) by applying the at least one parameter to the direction of the external electronic device (e.g., the external electronic device 200).

According to various embodiments, the method may further include transmitting a communication signal including the first orientation of the electronic device (e.g., the electronic device 101) to the external electronic device (e.g., the external electronic device 200) by the first communication module (e.g., the first communication module 410), and requesting adjustment of a position of the electronic device (e.g., the electronic device 101) identified by the external electronic device (e.g., the external electronic device 200) based on the first orientation and the second orientation by the first communication module (e.g., the first communication module 410).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a units implemented in hardware, software, or firmware, and may interchangeably be used with other terms, for example, logic, logic block, part, or circuitry. A module may be a single integral component, or a minimum units or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one sensor;
a first communication module configured to support a first communication scheme; and
a second communication module configured to support a second communication scheme,
wherein the first communication module is further configured to:
transmit a signal for discovery of an external electronic device configured to support the second communication scheme, and
receive a first response signal to the signal for discovery from the external electronic device, and
wherein the second communication module is further configured to:
perform at least one first operation for identifying a position of the external electronic device, based on identification that the external electronic device supports the second communication scheme based on the first response signal, and
perform at least one second operation for adjusting the position of the external electronic device, based on a first orientation of the electronic device identified based on the at least one sensor, and based on a second orientation of the external electronic device obtained through the first communication module.

2. The electronic device of claim 1, wherein as at least a part of performing the at least one first operation for identifying the position of the external electronic device, the second communication module is further configured to:
transmit a first communication signal based on the second communication scheme,
receive a second communication signal based on the second communication scheme, corresponding to the first communication signal, and
identify a distance between the electronic device and the external electronic device based on a transmission time of the first communication signal, a reception time of the second communication signal, and a process time of the external electronic device.

3. The electronic device of claim 2, wherein as at least a part of performing the at least one second operation for adjusting the position of the external electronic device, the second communication module is further configured to adjust an antenna characteristic of at least some of at least one antenna for at least one of transmitting the first communication signal or receiving the second communication signal, based on the first orientation and the second orientation.

4. The electronic device of claim 3,
wherein the second communication module includes a switch selectively connecting at least one of a plurality of stubs corresponding to the at least some of the at least one antenna to the at least some of the at least one antenna, and
wherein as at least a part of adjusting the antenna characteristic of the at least some of the at least one antenna, based on the first orientation and the second orientation, the second communication module is further configured to:
select at least one of the plurality of stubs based on the first orientation and the second orientation, and
control the switch to connect the selected stub to the at least some of the at least one antenna.

5. The electronic device of claim 3,
wherein the second communication module includes a switch configured to selectively connect at least one of a plurality of elements corresponding to the at least some of the at least one antenna to the at least some of the at least one antenna, and
wherein as at least a part of adjusting the antenna characteristic of the at least some of the at least one antenna, based on the first orientation and the second orientation, the second communication module is further configured to:
select at least one of the plurality of elements based on the first orientation and the second orientation, and
control the switch to connect the selected element to the at least some of the at least one antenna.

6. The electronic device of claim 3, wherein after adjusting the antenna characteristic of at least some of the at least one antenna for at least one of transmitting the first communication signal or receiving the second communication signal, based on the first orientation and the second orientation, the second communication module is further configured to:
transmit a third communication signal based on the second communication scheme,
receive a fourth communication signal based on the second communication scheme, corresponding to the third communication signal, and
identify a distance between the electronic device and the external electronic device based on a transmission time of the third communication signal, a reception time of the fourth communication signal, and a process time of the external electronic device.

7. The electronic device of claim 1, wherein as at least a part of performing the at least one first operation for identifying the position of the external electronic device, the second communication module is further configured to:
receive a fifth communication signal based on the second communication scheme from the external electronic device through a plurality of antennas of the second communication module, and
identify a direction of the external electronic device with respect to the electronic device, based on a difference in reception characteristics of the fifth communication signal at each of the plurality of respective antennas.

8. The electronic device of claim 7, wherein as at least a part of performing the at least one second operation for adjusting the position of the external electronic device, the second communication module is further configured to:
identify at least one parameter for correcting the direction of the external electronic device, based on the first orientation and the second orientation, and
correct the direction of the external electronic device by applying the at least one parameter to the direction of the external electronic device.

9. The electronic device of claim 7, wherein as at least part of performing the at least one second operation for adjusting the position of the external electronic device, the second communication module is further configured to:
identify at least one parameter for correcting the direction of the external electronic device based on the direction of the external electronic device, the first orientation, and the second orientation, and
correct the direction of the external electronic device by applying the at least one parameter to the direction of the external electronic device.

10. The electronic device of claim 1, wherein the first communication module is further configured to:
transmit a communication signal including the first orientation of the electronic device to the external electronic device, and
request adjustment of a position of the electronic device identified by the external electronic device, based on the first orientation and the second orientation.

11. A method performed by an electronic device including at least one sensor, a first communication module configured to support a first communication scheme, and a second communication module configured to support a second communication scheme, the method comprising:
transmitting, by the first communication module, a signal for discovery of an external electronic device configured to support the second communication scheme;
receiving, by the first communication module, a first response signal to the signal for discovery, from the external electronic device;
performing, by the second communication module, at least one first operation for identifying a position of the external electronic device based on identification that the external electronic device supports the second communication scheme based on the first response signal; and
performing, by the second communication module, at least one second operation for adjusting the position of the external electronic device, based on a first orientation of the electronic device identified based on the at least one sensor, and based on a second orientation of the external electronic device obtained through the first communication module.

12. The method of claim 11, wherein the performing, by the second communication module, of the at least one first operation for identifying the position of the external electronic device comprises:
transmitting, by the second communication module, a first communication signal based on the second communication scheme;
receiving, by the second communication module, a second communication signal based on the second communication scheme, corresponding to the first communication signal; and
identifying a distance between the electronic device and the external electronic device based on a transmission time of the first communication signal, a reception time of the second communication signal, and a process time of the external electronic device.

13. The method of claim 12, wherein the performing, by the second communication module, of the at least one second operation for adjusting the position of the external electronic device comprises adjusting an antenna characteristic of at least some of at least one antenna for at least one of transmitting the first communication signal or receiving the second communication signal, based on the first orientation and the second orientation.

14. The method of claim 13,
wherein the second communication module includes a switch selectively connecting at least one of a plurality of stubs corresponding to the at least some of the at least one antenna to the at least some of the at least one antenna, and
wherein the adjusting, by the second communication module, of the antenna characteristic of the at least some of the at least one antenna, based on the first orientation and the second orientation comprises:
selecting at least one of the plurality of stubs based on the first orientation and the second orientation; and
controlling the switch to connect the selected stub to the at least some of the at least one antenna.

15. The method of claim 13,
wherein the second communication module includes a switch selectively connecting at least one of a plurality of elements corresponding to the at least some of the at least one antenna to the at least some of the at least one antenna, and
wherein the adjusting, by the second communication module, of the antenna characteristic of the at least some of the at least one antenna based on the first orientation and the second orientation comprises:
selecting at least one of the plurality of elements based on the first orientation and the second orientation; and
controlling the switch to connect the selected element to the at least some of the at least one antenna.

16. The method of claim 13, wherein after adjusting the antenna characteristic of at least some of the at least one antenna for at least one of transmitting the first communication signal or receiving the second communication signal, based on the first orientation and the second orientation, comprises:
transmitting a third communication signal based on the second communication scheme;
receiving a fourth communication signal based on the second communication scheme, corresponding to the third communication signal; and
identifying a distance between the electronic device and the external electronic device based on a transmission time of the third communication signal, a reception time of the fourth communication signal, and a process time of the external electronic device.

17. The method of claim 11, wherein the performing, by the second communication module, the at least one first operation for identifying the position of the external electronic device comprises:
receiving a fifth communication signal based on the second communication scheme from the external electronic device through a plurality of antennas of the second communication module; and
identifying a direction of the external electronic device with respect to the electronic device, based on a difference in reception characteristics of the fifth communication signal at each of the plurality of respective antennas.

18. The method of claim 17, wherein the performing, by the second communication module, the at least one second operation for adjusting the position of the external electronic device, the second communication module comprises:
identifying at least one parameter for correcting the direction of the external electronic device, based on the first orientation and the second orientation; and
correcting the direction of the external electronic device by applying the at least one parameter to the direction of the external electronic device.

19. The method of claim 17, wherein the performing, by the second communication module, the at least one second operation for adjusting the position of the external electronic device comprises:
identifying at least one parameter for correcting the direction of the external electronic device based on the direction of the external electronic device, the first orientation, and the second orientation; and
correcting the direction of the external electronic device by applying the at least one parameter to the direction of the external electronic device.

20. The method of claim 11, further comprising:
transmitting a communication signal including the first orientation of the electronic device to the external electronic device; and
requesting adjustment of a position of the electronic device identified by the external electronic device, based on the first orientation and the second orientation.
